(19) United States
(12) Patent Application Publication
(10) Pub. No.: US 2020/0195886 A1
(43) Pub. Date: Jun. 18, 2020

(54) INFORMATION PROCESSING SYSTEM, INFORMATION PROCESSING DEVICE, AND INFORMATION PROCESSING METHOD

(71) Applicant: SHARP KABUSHIKI KAISHA, Sakai City (JP)

(72) Inventor: AKIHIRO KUMATA, Sakai City (JP)

(21) Appl. No.: 16/714,090

(22) Filed: Dec. 13, 2019

(30) Foreign Application Priority Data
Dec. 18, 2018 (JP) 2018-236603

(51) Int. Cl. H04N 7/14; H04L 12/18; H04N 7/15

(52) U.S. Cl. CPC H04N 7/147; H04L 12/1822; H04N 7/155; H04L 12/1818

(57) ABSTRACT

An information processing system 1 includes a server 2 and an output device. The server 2 can control a plurality of terminal devices A. The output device includes an inputter that is connectable with the plurality of terminal devices A by wire or wirelessly. The server 2 includes a controller 24. The controller 24 determines a terminal device connected to the inputter so that the terminal device A can input a signal, among the plurality of terminal devices A.

### BACKGROUND OF THE INVENTION

### Field of the Invention

The present invention relates to an information processing system, an information processing device, and an information processing method.

### Description of the Background Art

A broadcast receiving apparatus is disclosed in Japanese Unexamined Patent Application Publication No. 2014-021493 (hereinafter, Patent Document 1). The broadcast receiving apparatus disclosed in Patent Document 1 enables an external input terminal to which an external input device supporting user's voice is connected, and displays video received from the external input device to aid user operations using voice recognition technology. Specifically, the broadcast receiving apparatus disclosed in Patent Document 1 includes an external input terminal, a trigger word setter, a saver, a voice recognizer, a controller, and a display. The broadcast receiving apparatus is also communicably connected to a server.

The external input device is connected to the external input terminal. The trigger word setter sets a trigger word for the external input device. The saver saves trigger words and external input terminals to which external input devices corresponding to the respective trigger words are connected such that they are matched. The voice recognizer converts a user's voice into a digital signal and transmits the digital signal to the server. The server generates text information corresponding to the user's voice based on the digital signal.

The controller determines whether or not the user's voice contains the trigger word based on the text information received from the server. If the user's voice contains the trigger word, then the controller enables the external input terminal corresponding to the trigger word and controls the display to display a video received at the external input terminal corresponding to the trigger word. Trigger words disclosed in Patent Document 1 are, for example, voices of “VIDEO”, “DVD”, and “Blu-ray”.

However, in the broadcast receiving apparatus disclosed in Japanese Unexamined Patent Application No. 2014-021493, when there are a plurality of terminal devices that input video to the external input terminals, the server cannot identify a terminal device connected to the enabled external input terminal among the plurality of terminal devices. Therefore, when a user operates the terminal device connected to the enabled external input terminal among the plurality of terminal devices, the user has to identify a terminal device to be operated from the plurality of terminal devices, which is complicated.

An object of the present invention is to provide an information processing system, an information processing device, and an information processing method that allow a user to easily operate a terminal device connected to an enabled terminal among a plurality of terminal devices.

### SUMMARY OF THE INVENTION

According to a first aspect of the present invention, an information processing system includes a server and an output device. The server can control a plurality of terminal devices. The output device includes an inputter that is connectable with the plurality of terminal devices by wire or wirelessly. The server includes a controller that determines a terminal device connected to the inputter, the terminal device inputting a signal to the inputter, among the plurality of terminal devices.

According to a second aspect of the present invention, an information processing device includes a controller. The controller can control a plurality of terminal devices. The plurality of terminal devices are connectable to an inputter included in an output device by wire or wirelessly. The controller determines a terminal device connected to an enabled terminal among the plurality of terminal devices. The enabled terminal indicates an enabled input terminal among the plurality of input terminals.

According to a third aspect of the present invention, an information processing method uses a server and an output device. The server can control a plurality of terminal devices. The output device includes an inputter that is connectable with the plurality of terminal devices by wire or wirelessly. The information processing method includes determining, by the server, a terminal device connected to the inputter, the terminal device inputting a signal to the inputter, among the plurality of terminal devices.

According to the information processing system, the information processing device, and the information processing method of the present invention, it is possible to allow a user to easily operate a terminal device connected to an enabled terminal among the plurality of terminal devices.

### BRIEF DESCRIPTION OF THE DRAWINGS

FIG. 1 is a block diagram illustrating an information processing system according to a first embodiment of the present invention;

FIG. 2 is a block diagram illustrating a server;

FIG. 3 is a block diagram illustrating a first terminal device;

FIG. 4 is a block diagram illustrating a second terminal device;

FIG. 5 is a block diagram illustrating a smart speaker;

FIG. 6 is a block diagram illustrating a display device;

FIG. 7 shows a server table;

FIG. 8 shows a device table;

FIG. 9 is a first flowchart illustrating a first process of the information processing system;

FIG. 10 is a second flowchart illustrating the first process of the information processing system;

FIG. 11 shows the device table after a first update;

FIG. 12 shows the server table after a first update;

FIG. 13 is a flowchart illustrating a first operation of the first terminal device;

FIG. 14 is a flowchart illustrating a first operation of the server;

FIG. 15 is a schematic diagram illustrating a second process of the information processing system;

FIG. 16 shows the device table after a second update;

FIG. 17 is a first flowchart illustrating the second process of the information processing system;

FIG. 18 is a second flowchart illustrating the second process of the information processing system;

FIG. 19 is a third flowchart illustrating the second process of the information processing system;

FIG. 20 shows the server table after a second update;

FIG. 21 is a flowchart illustrating a second operation of the first terminaldevice;

FIG. 22 is a first flowchart illustrating a second operation of the server;

FIG. 23 is a second flowchart illustrating the second operation of the server;

FIG. 24 is a flowchart illustrating a third process of the information processing system;

FIG. 25 is a first flowchart illustrating a fourth process of the information processing system;

FIG. 26 is a second flowchart illustrating the fourth process of the information processing system;

FIG. 27 is a third flowchart illustrating the fourth process of the information processing system;

FIG. 28 is a fourth flowchart illustrating the fourth process of the information processing system;

FIG. 29 is a fifth flowchart illustrating the fourth process of the information processing system;

FIG. 30 shows the server table after a third update;

FIG. 31 is a schematic diagram illustrating the fourth process of the information processing system;

FIG. 32 shows the server table after a fourth update;

FIG. 33 is a first flowchart illustrating a third operation of the server;

FIG. 34 is a second flowchart illustrating the second operation of the server;

FIG. 35 is a flowchart illustrating the third operation of the first terminal device; and

FIG. 36 is a flowchart illustrating an operation of a smart speaker.

### DESCRIPTION OF THE PREFERRED EMBODIMENTS

Hereinafter, embodiments according to the present invention will be described with reference to drawings. In the drawings, like reference numerals will be used for identical or corresponding parts to omit duplicate descriptions.

### First Embodiment

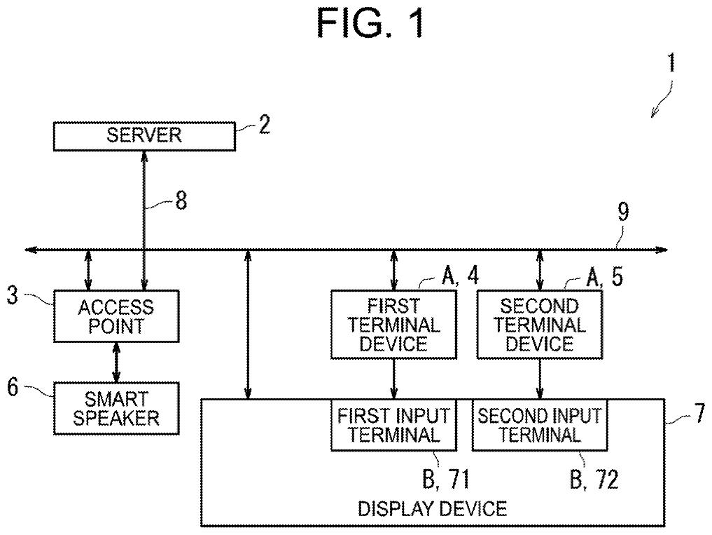

With reference to FIG. 1, an information processing system 1 according to a first embodiment of the present invention will be described. FIG. 1 is a block diagram illustrating the information processing system 1 according to the first embodiment of the present invention.

The information processing system 1 is used for a meeting, for example. As illustrated in FIG. 1, the information processing system 1 includes a server 2, an access point 3, a plurality of terminal devices A, a smart speaker 6, and a display device 7. In the first embodiment, the plurality of terminal devices A include a first terminal device 4 and a second terminal device 5.

For example, if a voice uttered by a user contains a predetermined keyword, the server 2 switches a display screen of the display device 7 in response to the voice uttered by the user. It is noted that, in the following description, a voice uttered by a user is sometimes referred to as a “user's voice”.

The server 2 is an example of an information processing device according to the present invention.

The access point 3 connects an Internet line 8 and a Local Area Network (LAN) cable 9. To the LAN cable 9, the first terminal device 4, the second terminal device 5, and the display device 7 are connected. The server 2 communicates with each of the first terminal device 4 and the second terminal device 5 via the Internet line 8, the access point 3, and the LAN cable 9. It is noted that the server 2 is not communicatively connected to the display device 7.

The access point 3 is connected to the smart speaker 6 via a wireless LAN. The server 2 communicates with the smart speaker 6 via the Internet line 8, the access point 3, and the wireless LAN.

It is noted that the access point 3 may be connected to each of the first terminal device 4 and the second terminal device 5 via the wireless LAN, or may be connected to the smart speaker 6 via the LAN cable 9.

Each of the first terminal device 4 and the second terminal device 5 is an information processing device. The first terminal device 4 and the second terminal device 5 are connected to the display device 7 to output image data to the display device 7.

The first terminal device 4 and the second terminal device 5 may be any devices that can output image data. In the first embodiment, the first terminal device 4 and the second terminal device 5 are personal computers (PCs).

In the first embodiment, the information processing system includes two terminal devices A including the first terminal device 4 and the second terminal device 5. However, the present invention is not limited to this. The information processing system 1 may include three or more terminal devices A.

The terminal device A is not limited to a PC. The terminal device A may be any devices that can transmit information such as image data and/or audio data to the display device 7. The terminal device A may be, for example, a DVD player or an audio player.

The smart speaker 6 collects a voice uttered by a user, converts the collected voice into audio data (digital data), and transmits the audio data to the server 2. The smart speaker 6 also outputs audio based on the audio data (digital data) received from the server 2.

The smart speaker 6 is an example of a reception device according to the present invention.

The display device 7 outputs the information received from the terminal device A. In the first embodiment, the display device 7 displays an image. The display device 7 includes a plurality of input terminals B. In the first embodiment, the plurality of input terminals B include a first input terminal 71 and a second input terminal 72. The plurality of input terminals B are an example of an inputter of the present invention.

A device capable of transmitting image data and/or audio data is connected to the first input terminal 71 and the second input terminal 72. The first input terminal 71 and the second input terminal 72 are each, for example, a D-SUB terminal, an HDMI (registered trademark) terminal, or a DisplayPort.

In the first embodiment, the first terminal device 4 is connected to the first input terminal 71. The second terminal device 5 is connected to the second input terminal 72. In the first embodiment, the display device 7 enables any one of the first input terminal 71 and the second input terminal 72, and displays an image indicated by image data received at the enabled input terminal B.

The display device 7 outputs information transmitted to an enabled terminal by the terminal device A connected to the enabled terminal. The display device 7 does not output information transmitted to a disabled terminal by the terminal device A connected to the disabled terminal. The enabled terminal indicates an enabled terminal device A among the plurality of terminal devices A. The disabled terminal indicates a disabled terminal device A among the plurality of terminal devices A. Connecting to the enabled terminal is an example of connecting to the inputter so that the terminal device A can input a signal to the inputter, in the present invention. Connecting to the disabled terminal is an example of connecting to the inputter so that the terminal device A cannot input a signal to the inputter, in the present invention.

The display device 7 is an example of an output device of the present invention.

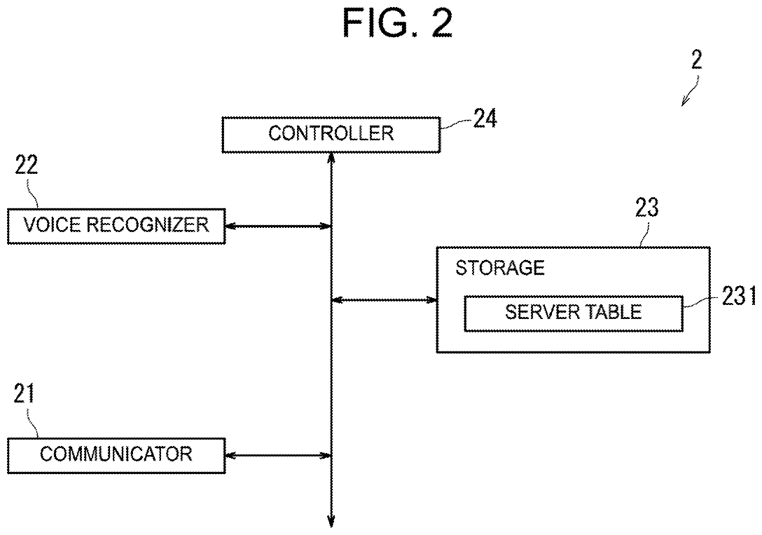

Next, the server 2 will be described with reference to FIGS. 1 and 2. FIG. 2 is a block diagram illustrating the server 2. As illustrated in FIG. 2, the server 2 includes a communicator 21, a voice recognizer 22, a storage 23, and a controller 24.

The communicator 21 is connected to the Internet line 8. For example, the communicator 21 includes a LAN board or a LAN module. The communicator 21 communicates with the first terminal device 4, the second terminal device 5, and the smart speaker 6.

The voice recognizer 22 converts the audio data received from the smart speaker 6 into text data using voice recognition technology. The voice recognizer 22 includes, for example, a voice recognition Large Scale Integration (LSI).

The storage 23 includes, for example, a semiconductor memory such as a Random Access Memory (RAM) and a Read Only Memory (ROM). The storage 23 further includes a storage device such as a Hard Disk Drive (HDD). The storage 23 stores a control program to be executed by the controller 24. The storage 23 stores a server table 231. The server table 231 will be described later.

The controller 24 includes a processor such as a Central Processing Unit (CPU) or a Micro Processing Unit (MPU). The controller 24 (computer) controls the operation of the server 2 based on the control program (computer program) stored in the storage 23.

The server 2 has been described above with reference to FIGS. 1 and 2. It is noted that the server 2 illustrated in FIG. 2 includes the voice recognizer 22, and otherwise, the controller 24 may have the function of the voice recognizer 22. In this case, the voice recognize 22 is eliminated.

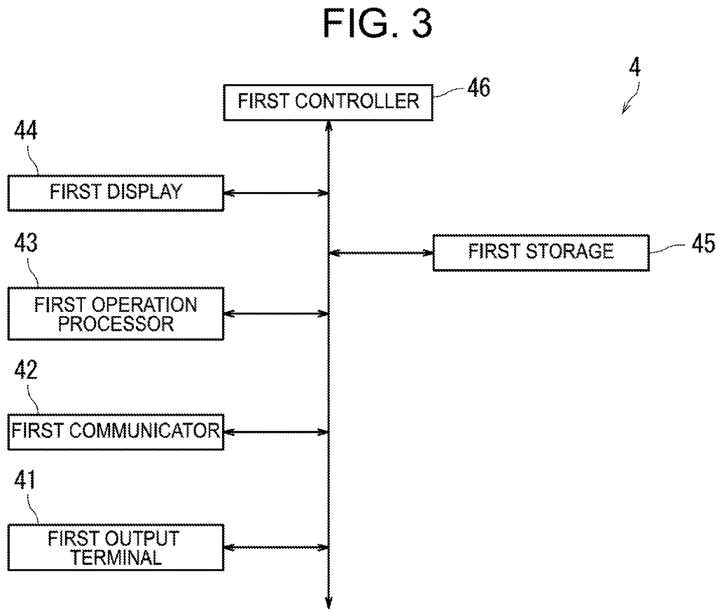

Next, the first terminal device 4 will be described with reference to FIGS. 1 and 3. FIG. 3 is a block diagram illustrating the first terminal device 4.

As illustrated in FIG. 3, the first terminal device 4 includes a first output terminal 41, a first communicator 42, a first operation processor 43, a first display 44, a first storage 45, and a first controller 46.

The first output terminal 41 outputs image data. The first output terminal 41 is connected to the first input terminal 71 of the display device 7. The first output terminal 41 is, for example, a D-SUB terminal, an HDMI (registered trademark) terminal, or a DisplayPort. If the first input terminal 71 of the display device 7 is enabled, the image output from the first output terminal 41 is displayed by the display device 7.

The first communicator 42 is connected to the LAN cable 9. The first communicator 42 includes, for example, a LAN board or a LAN module. The first communicator 42 controls communication with the server 2. The first communicator 42 also controls communication with the second terminal device 5 and the display device 7.

The first operation processor 43 receives an instruction for the first terminal device 4 from the outside. The first operation processor 43 is operated by a user to receive an instruction from the user.

The first operation processor 43 outputs a signal corresponding to a user operation to the first controller 46. As a result, the first terminal device 4 performs an operation according to the operation received by the first operation processor 43. The first operation processor 43 includes, for example, a pointing device and a keyboard. It is noted that the first operation processor 43 may include a touch sensor. The touch sensor is overlaid on the display surface of the first display 44.

The first display 44 displays various types of information. The first display 44 is, for example, a liquid crystal display or an organic electroluminescence (EL) display. It is noted that, in the case where the touch sensor is overlaid on the display surface of the first display 44, the first display 44 functions as a touch display.

The first storage 45 includes a semiconductor memory such as a RAM and a ROM. The first storage 45 further includes a storage device such as an HDD. The first storage 45 stores a control program to be executed by the first controller 46.

The first controller 46 includes a processor such as a CPU. The first controller 46 (computer) controls the operation of the first terminal device 4 based on the control program (computer program) stored in the first storage 45.

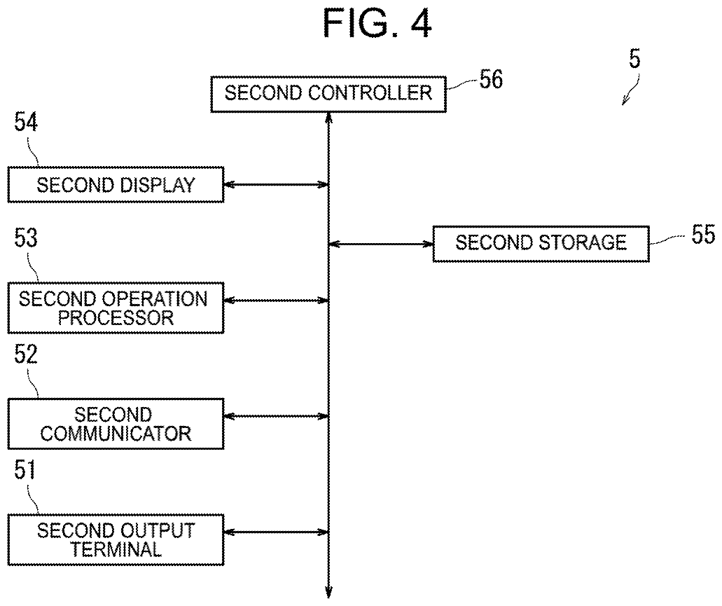

Next, the second terminal device 5 will be described with reference to FIGS. 3 and 4. FIG. 4 is a block diagram illustrating the second terminal device 5.

As illustrated in FIGS. 3 and 4, the second terminal device 5 includes a second output terminal 51, a second communicator 52, a second operation processor 53, a second display 54, a second storage 55, and a second controller 56.

The second output terminal 51 has the same configuration as the first output terminal 41 and is connected to the second input terminal 72 of the display device 7. The second communicator 52 has the same configuration as the first communicator 42 and is connected to the LAN cable 9. The second operation processor 53 has the same configuration as the first operation processor 43 and receives an instruction for the second terminal device 5 from the outside. The second display 54 has the same configuration as the first display 44 and displays various types of information. The second storage 55 has the same configuration as the first storage 45 and stores a control program to be executed by the second controller 56. The second controller 56 has the same configuration as the first controller 46 and controls the operation of the second terminal device 5.

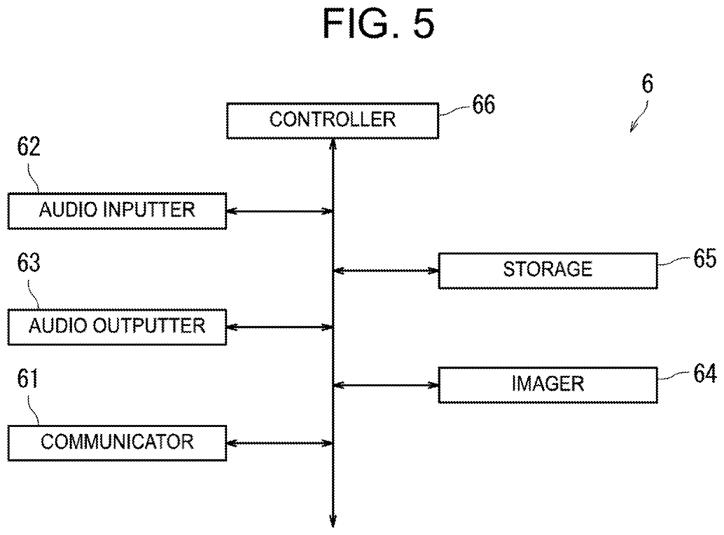

Next, the smart speaker 6 will be described with reference to FIGS. 1 and 5. FIG. 5 is a block diagram illustrating the smart speaker 6.

As illustrated in FIG. 5, the smart speaker 6 includes a communicator 61, an audio inputter 62, an audio outputter 63, an imager 64, a storage 65, and a controller 66.

The communicator 61 is connected to the access point 3. The communicator 61 controls communication with the server 2.

The communicator 61 transmits audio data to the server 2. The communicator 61 also receives audio data from the server 2. The communicator 61 is, for example, a wireless LAN board or a wireless LAN module.

The audio inputter 62 collects voice uttered by a user and converts the collected. voice into an analog electric signal. The analog electric signal is input to the controller 66. The audio inputter 62 is, for example, a microphone. The audio outputter 63 outputs audio corresponding to the audio data received from the server 2. The audio outputter 63 is, for example, a speaker.

The imager 64 captures an image displayed by the display device 7. The imager 64 includes, for example, a digital camera.

The storage 65 includes a semiconductor memory such as a RAM and a ROM. The storage 65 may further include a storage device such as art HDD. The storage 65 stores a control program to be executed by the controller 66.

The controller 66 includes a processor such as a CPU or an MPU. The controller 66 (computer) controls the operation of the smart speaker 6 based on the control program (computer program) stored in the storage 65.

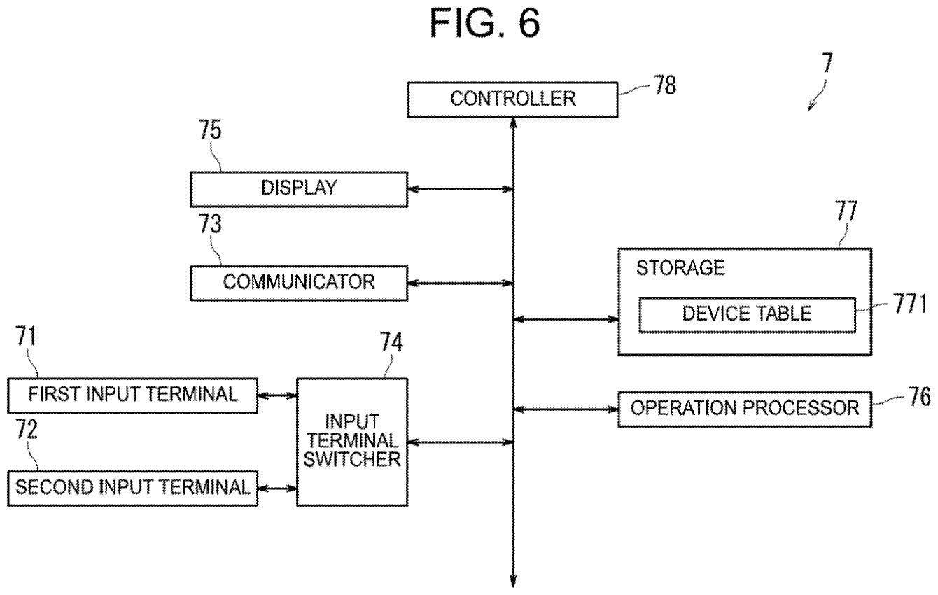

Next, the display device 7 will be described with reference to FIGS. 1 and 6. FIG. 6 is a block diagram illustrating the display device 7.

As illustrated in FIGS. 1 and 6, the display device 7 includes a communicator 73, an input terminal switcher 74, a display 75, a storage 77, and a controller 78, in addition to the first input terminal 71 and the second input terminal 72.

The communicator 73 is connected to the LAN cable 9. The communicator 73 includes, for example, a LAN board or a LAN module. The communicator 73 controls communication with the first terminal device 4 and the second terminal device 5.

The input terminal switcher 74 selects and enables one input terminal B, which is one of the first input terminal 71 and the second input terminal 72.

The display 75 displays an image received by the enabled input terminal B among the first input terminal 71 and the second input terminal 72. The display 75 is, for example, a liquid crystal display or an organic EL display it is noted that the display 75 may include a touch sensor. In other words, the display 75 may be a touch display.

The operation processor 76 receives an instruction for the display device 7 from the outside. The operation processor 76 is operated by a user and receives an instruction from a user. The operation processor 76 outputs a signal corresponding to a user operation to the controller 78. As a result, the display device 7 performs an operation according to the operation received by the operation processor 76.

The operation processor 76 includes, for example, a remote controller, operation keys, and/or a touch panel. The operation processor 76 receives selection of the input terminal B to be enabled among the first input terminal 71 and the second input terminal 72. The user can select the input terminal B to be enabled among the first input terminal 71 and the second input terminal 72 via the operation processor 76.

The storage 77 includes a semiconductor memory such as a RAM and a ROM. The storage 77 may further include a storage device such as an HDD. The storage 77 stores a control program to be executed by the controller 78.

The storage 77 stores a device table 771. The device table 771 will be described later.

The controller 78 includes a processor such as a CPU or an MPU. The controller 78 (computer) controls the operation of the display device 7 based on the control program (computer program) stored in the storage 77.

If the first input terminal 71 is selected via the operation processor 76, the controller 78 controls the input terminal switcher 74 so that the input terminal switcher 74 enables the first input terminal 71. If the second input terminal 72 is selected via the operation processor 76, the controller 78 controls the input terminal switcher 74 so that the input terminal switcher 74 enables the second input terminal 72.

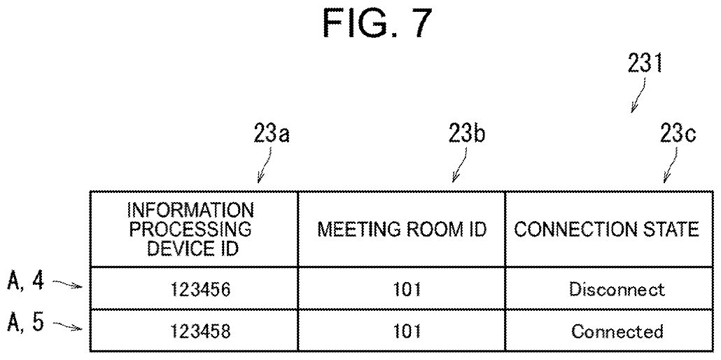

Next, the server table 231 illustrated in FIG. 2 will be described with reference to FIG. 7. FIG. 7 shows the server table 231. The server table 231 is a table for the server 2 to manage the plurality of terminal devices A.

As shown in FIG. 7, the server table 231 includes information 23a indicating an information processing device ID, information 23b indicating a meeting room ID, and information 23c indicating a connection state.

The server table 231 is information in which an information processing device ID, a meeting room ID, and a connection state are associated with each terminal device A.

The information processing device ID is information for identifying each of the plurality of terminal devices A from one another. A different information processing device ID is assigned to the respective terminal devices A in advance. In the first embodiment, the information processing device ID of the first terminal device 4 is information processing device ID “123456”. The information processing device ID of the second terminal device 5 is information processing device ID “123458”.

The meeting room ID is information for specifying a meeting room in which each of the plurality of terminal devices A is installed. In the first embodiment, the first terminal device 4 and the second terminal device 5 are installed in the meeting room with meeting room ID “101”.

In the first embodiment, each of the information processing device ID and the meeting room ID is a number. However, the present invention is not limited to this. Each of the information processing device ID and the meeting room ID may be, for example, a symbol including at least one of a character, a number, and a mark.

The connection state indicates a connection state of the terminal device A with respect to the input terminal B. The connection state of the terminal device A indicates any one of a disconnected state, an enabled state, and a disabled state.

The disconnected state indicates a state in which the terminal device A is not connected to the input terminal B. In this case, an image output from the terminal device A is not displayed on the display device 7. In the first embodiment, if the terminal device A is in the disconnected state, “Disconnect” is indicated in the connection state column of the server table 231.

The enabled state indicates a state in which the terminal device A is connected to the enabled input terminal B. In this case, an image output from the terminal device A is displayed on the display device 7. In the first embodiment, if the terminal device A is in the enabled state, “Displayed” is indicated in the connection state column of the server table 231.

The disabled state indicates a state in which the terminal device A is connected to the disabled input terminal B. In this case, an image output from the terminal device A is not displayed on the display device 7. In the first embodiment, if the terminal device A is in the disabled state, “Connected” is indicated in the connection state column of the server table 231.

In the server table 231 of FIG. 7, the connection state of the first terminal device 4 is “Disconnected”, and the connection state of the second terminal device 5 is “Connected”. Consequently, based on the server table 231, the controller 24 of the server 2 recognizes that the first terminal device 4 is not connected to the input terminal B, and also recognizes that the second terminal device 5 is connected to the disabled input terminal B.

The server 2 can recognize the connection state of each of the plurality of terminal devices A based on the server table 231.

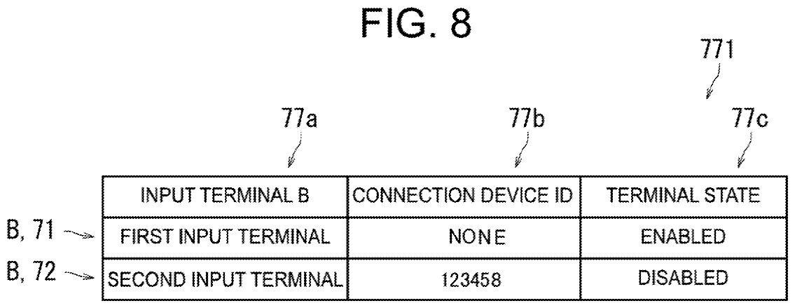

Next, the device table 771 illustrated in FIG. 6 will be described with reference to FIG. 8. FIG. 8 shows the device table 771. The device table 771 is a table for the display device 7 to manage the connection state of the terminal device A with respect to the input terminal B.

As shown in FIG. 8, the device table 771 includes information 77a indicating the input terminals B, information 77b indicating a connection device ID, and information 77c indicating a terminal state.

The device table 771 is information in which a connection device ID and a terminal state are associated with each input terminal B.

The connection device ID indicates the information processing device ID of the terminal device A connected to the input terminal B.

The terminal state is information indicating whether or not each of the plurality of input terminals B is enabled. In the first embodiment, if the input terminal B is enabled, “Enabled” is indicated in the terminal state column of the device table 771. If the input terminal B is disabled, “Disabled” is displayed in the terminal state column of the device table 771

The user can select whether or not to enable each of the plurality of input terminals B by operating the operation processor 76 illustrated in FIG. 6.

In the device table 771 of FIG. 8, the connection device ID of the first input terminal 71 is “none”, and the terminal state of the first input terminal 71 is “Enabled”. Accordingly, based on the device table 771, the controller 78 of the display device 7 recognizes that the terminal device A is not connected to the first input terminal 71 and the first input terminal 71 is enabled.

Further, in the device table 771 of FIG. 8, the connection device ID of the second input terminal 72 is information processing device ID “123458” of the second terminal device 5 and the terminal state of the second input terminal 72 is “Disabled”. Accordingly, based on the device table 771, the controller 78 of the display device 7 recognizes that the second terminal device 5 is connected to the second input terminal 72 but the second input terminal 72 is disabled.

The display device 7 can recognize the connection information based on the device table 771. The connection information is information indicating which one of the plurality of terminal devices A is connected to the input terminal B. The device table 771 may be stored inn the storage 23 of the server 2. In this case, the information included in the device table 771 is transmitted from the display device 7 to the server 2.

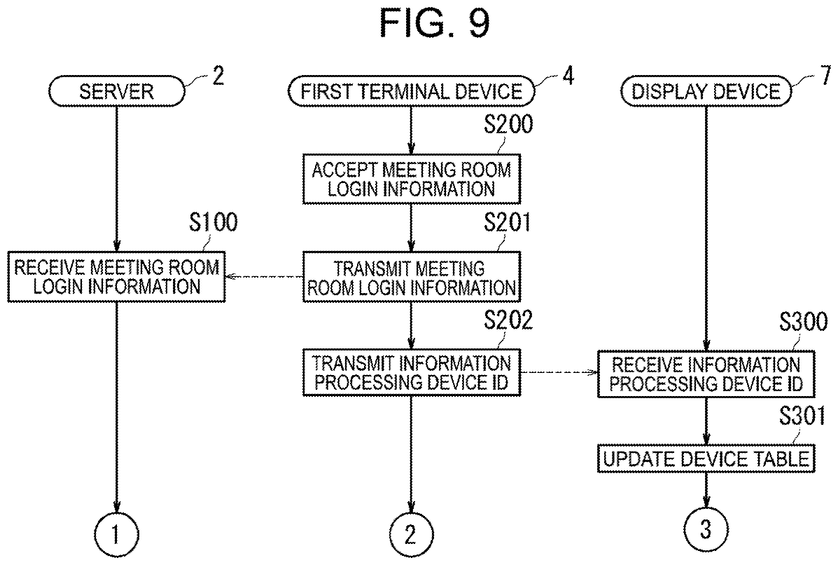

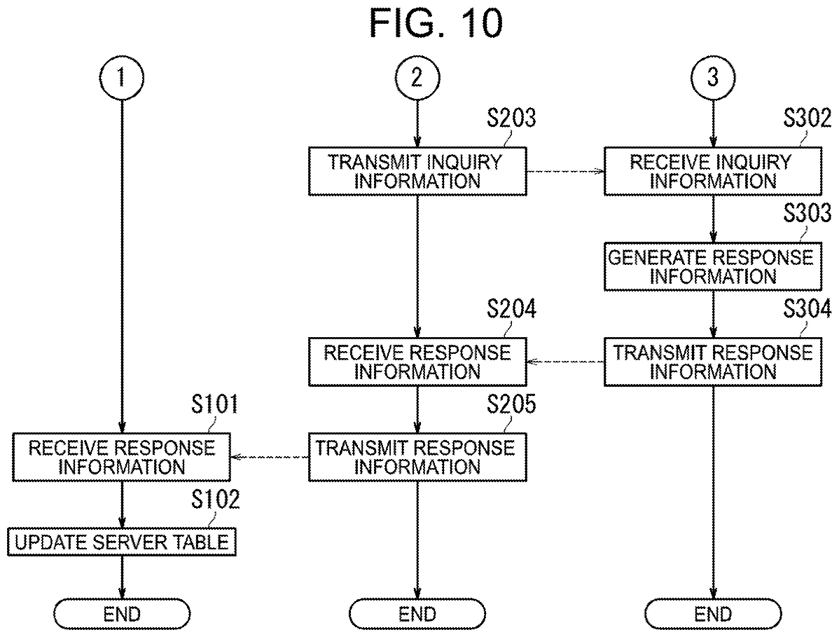

Next, a first process of the information processing system 1 will be described with reference to FIGS. 9 to 12. FIG. 9 is a first flowchart illustrating the first process of the information processing system 1. FIG. 10 is a second flowchart illustrating the first process of the information processing system 1. The first process is a process performed by the information processing system 1 when a user participates in a meeting.

In the first embodiment, at a start of the first process, the server 2 has the server table 231 shown in FIG. 7, and the display device 7 has the device table 771 shown in FIG. 8.

As illustrated in FIG. 9, in step S200, the first operation processor 43 of the first terminal device 4 accepts meeting room login information. The meeting room login information is information indicating that the terminal device A is connected to the server 2.

In step S201, the first controller 46 controls the first communicator 42 so that the first communicator 42 transmits the meeting room login information to the server 2.

In step S100, the communicator 21 of the server 2 receives the meeting room login information.

In step S202, the user connects the first terminal device 4 to the first input terminal 71 of the display device 7. In the first embodiment, the first output terminal 41 of the first terminal device 4 is connected to the first input terminal 71 via an HDMI (registered trademark) cable. When the first terminal device 4 is connected to the first input terminal 71, the first controller 46 controls the first output terminal 41 so that the first output terminal 41 transmits the information processing device ID of the first terminal device 4 to the display device 7. As a result, the information processing device ID of the first terminal device 4 is transmitted from the first terminal device 4 to the display device 7.

In the first embodiment, the information processing device ID of the first terminal device 4 is transmitted from the first terminal device 4 to the display device 7 using CEC over HDMI (registered trademark).

In step S300, the first input terminal 71 of the display device 7 receives the information processing device ID of the first terminal device 4.

In step S301, the controller 78 updates the device table 771 shown in FIG. 8 to generate the device table 771 after a first update.

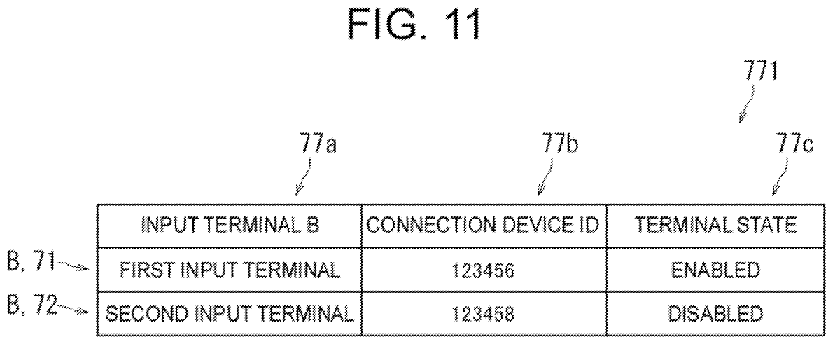

FIG. 11 shows the device table 771 after the first update.

As shown in FIG. 11, in the device table 771 after the first update, information processing device ID “123456” of the first input terminal 71 is added in the item of the first input terminal 71. Specifically, in the device table 771 after the first update, the column of the connection device ID of the first input terminal 71 is changed from “none” to information processing device ID “123456” of the first terminal device 4.

The controller 78 recognizes that the first terminal device 4 is connected to the enabled first input terminal 71 based on the device table 771 after the first update.

As illustrated in FIGS. 10 and 11, in step S203, the first controller 46 controls the first communicator 42 so that the first communicator 42 transmits inquiry information to the display device 7. As a result, the inquiry information is transmitted from the first terminal device 4 to the display device 7. In the first embodiment, the inquiry information is transmitted via a LAN.

The inquiry information is information for inquiring the connection state of the terminal device A with respect to the input terminal B.

In step S302, the communicator 73 of the display device 7 receives the inquiry information.

In step S303, the controller 78 generates response information in response to the inquiry information based on the device table 771 after the first update shown in FIG. 11. The response information is information indicating the device table 771 after the first update.

In step S304, the controller 78 controls the communicator 73 so that the communicator 73 transmits the response information to the first terminal device 4. If the process of step S304 ends, the processing of the display device 7 ends.

In step S204, the first communicator 42 of the first terminal device 4 receives the response information.

In step S205, the first controller 46 controls the first communicator 42 so that the first communicator 42 transmits the response information to the server 2. If the process of step S205 ends, the processing of the first terminal device 4 ends.

In step S101, the communicator 21 of the server 2 receives the response information. Specifically, the communicator 21 of the server 2 receives the response information from the display device 7 via the first terminal device 4. As a result, the server 2 recognizes that the first terminal device 4 is connected to the enabled first input terminal 71 based on the response information. Further, the server 2 recognizes that the second terminal device 5 is connected to the disabled second input terminal 72 based on the response information.

In step S102, the controller 24 of the server 2 updates the server table 231 shown in FIG. 7 based on the response information to generate the server table 231 after a first update.

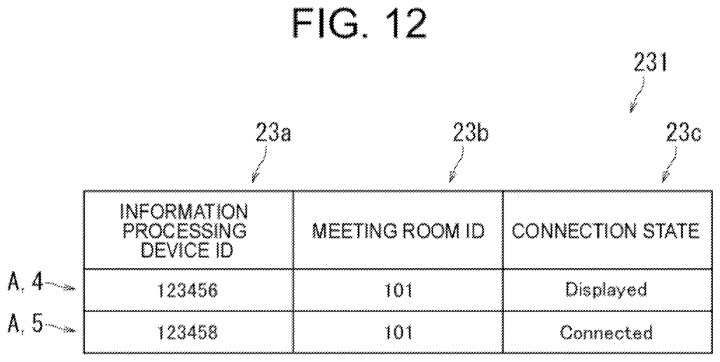

FIG. 12 shows the server table 231 after the first update.

As shown in FIG. 12, in the server table 231 after the first update, the connection state column is updated to the contents reflecting the response information generated by the display device 7 in step S303. In the server table 231 after the first update, the connection state column of the first terminal device 4 is changed from “Disconnect” to “Displayed”. The connection state column of the second terminal device 5 remains “Connected”. If the process of step S102 ends, the processing of the server 2 ends.

As described above with reference to FIGS. 9 to 12, when the first terminal device 4 is connected to the first input terminal 71 in step S301 of FIG. 9, the display device 7 updates the device table 771 to the device table 771 after the first update. Therefore, when the terminal device A is newly connected to the input terminal B, the display device 7 can recognize the latest connection information based on the device table 771 after the first update.

In step S102 of FIG. 10, the server 2 updates the server table 231 based on the device table 771 after the first update. Therefore, when the terminal device A is newly connected to the input terminal B, the server 2 can recognize the latest connection state of the terminal device A based on the updated server table 231.

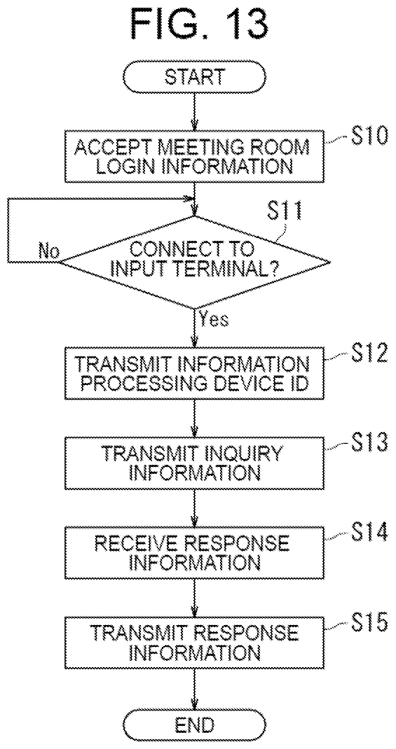

Next, a first operation of the first terminal device 4 will he described with reference to FIG. 13, FIG. 13 is a flowchart illustrating the first operation of the first terminal device 4. The first operation of the first terminal device 4 indicates an operation of the first terminal device 4 when the information processing system 1 performs the first process illustrated in FIGS. 9 and 10.

As illustrated in FIG. 13, in step S10, the first operation processor 43 of the first terminal device 4 accepts the meeting room login information.

In step S11, the first controller 46 determines whether or not the first output terminal 41 is connected to the input terminal B of the display device 7. If the first controller 46 determines that the first output terminal 41 is connected to the input terminal B of the display device 7 (Yes in step S11), the processing proceeds to step S12. If the first controller 46 determines that the first output terminal 41 is not connected to the input terminal B of the display device 7 (No in step S11), the process of step S11 is repeated.

In step S12, the first controller 46 controls the first output terminal 41 so that the first output terminal 41 transmits the information processing device ID of the first terminal device 4 to the display device 7.

In step S13, the first controller 46 controls the first communicator 42 so that the first communicator 42 transmits the inquiry information to the display device 7.

In step S14, the first communicator 42 receives the response information from the display device 7.

In step S15, the first controller 46 controls the first communicator 42 so that the first communicator 42 transmits the response information to the server 2. As a result, the processing ends.

As described above with reference to FIG. 13, in step S1.4 and step S15, the response information is transmitted from the display device 7 to the server 2 via the first terminal device 4. Therefore, even if the display device 7 and the server 2 cannot directly communicate with each other, the server 2 can acquire the response information.

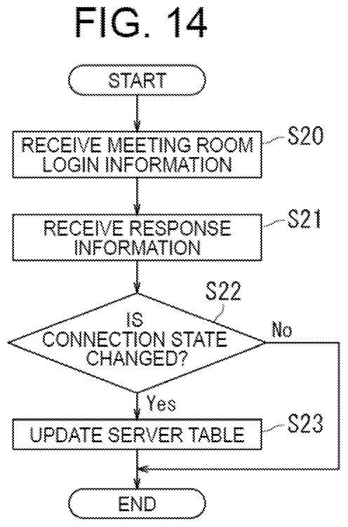

Next, a first operation of the server 2 will be described with reference to FIG. 14. FIG. 14 is a flowchart illustrating the first operation of the server 2. The first operation of the server 2 indicates an operation of the server 2 when the information processing system 1 performs the first process illustrated in FIGS. 9 and 10.

In step S20, the communicator 21 receives meeting room login information from the first terminal device 4. As a result, the server 2 is connected to the first terminal device 4.

In step S21, the communicator 21 receives the response information from the first terminal device 4.

In step S22, the controller 24 determines whether or not there is a change in the connection state of the server table 231 as compared with the response information. If the controller 24 determines that there is a change in the connection state (Yes in step S22), the processing proceeds to step S23. If the controller 24 determines that there is no change in the connection state (No in step S22), the processing ends.

In step S23, the controller 24 updates the server table 231 so that the connection state of the server table 231 has contents reflecting the response information. Therefore, the controller 24 can recognize the latest connection state of the terminal device A based on the updated server table 231. If the process of step S23 ends, the processing ends.

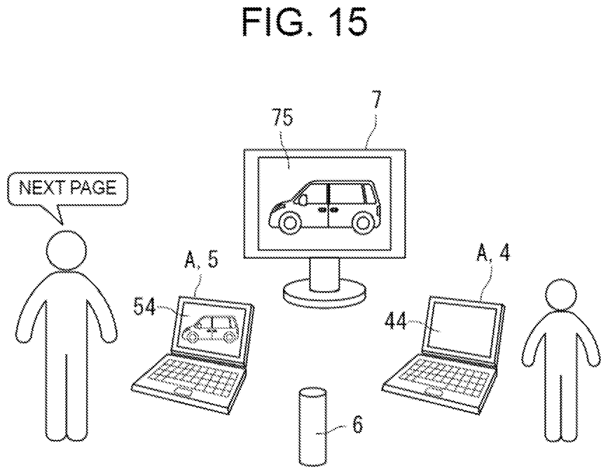

Next, a second process of the information processing system 1 will be described with reference to FIGS. 15 to 20. The second process is a process performed by the information processing system 1 when the smart speaker 6 receives a voice indicating a predetermined instruction.

FIG. 15 is a schematic diagram illustrating the second process of the information processing system 1.

As illustrated in FIG. 15, when a user inputs a voice indicating a predetermined instruction to the smart speaker 6, the information processing system 1 executes the second process. The predetermined instruction indicates an instruction related to an image to be displayed on the display device 7. The instruction related to the image indicates includes, for example, an instruction for controlling an image to be displayed on the display device 7 and/or an instruction for controlling a sound output together with the image. The instruction to control the image includes, for example, at least one of an instruction to change an image, an instruction to enlarge or reduce an image, and an instruction to erase or display an image. The instruction to control the sound includes, for example, an instruction to increase or decrease the sound volume.

The second process is performed after the end of the first process illustrated in FIGS. 9 to 12.

In the first embodiment, the input terminal B to be enabled by the user operating the operation processor 76 in a period from the start of the first process to the start of the second process is changed from the first input terminal 71 to the second input terminal 72. As a result, the device table 771 after the first update shown in FIG. 11 is updated to the device table 771 after a second update.

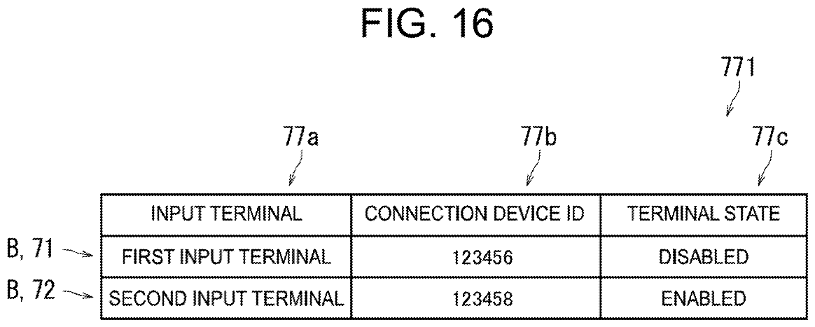

FIG. 16 shows the device table 771 after the second update.

As shown in FIG. 16, in the device table 771 after the second update, the terminal state column of the first input terminal 71 is changed from “Enabled” to “Disabled”. In addition, the terminal state column of the second input terminal 72 is changed from “Disabled” to “Enabled”.

In the first embodiment, at the start of the second process, the server 2 has the server table 231 after the first update shown in FIG. 12, and the display device 7 has the device table 771 after the second update shown in FIG. 16.

As illustrated in FIGS. 15 and 16, at the start of the second process, the display device 7 does not display an image transmitted by the first terminal device 4 but displays an image transmitted by the second terminal device 5. Accordingly, the same image as the image displayed on the second display 54 of the second terminal device 5 is displayed on the display 75 of the display device 7.

In the following, the procedure of the second process of the information processing system 1 will be described.

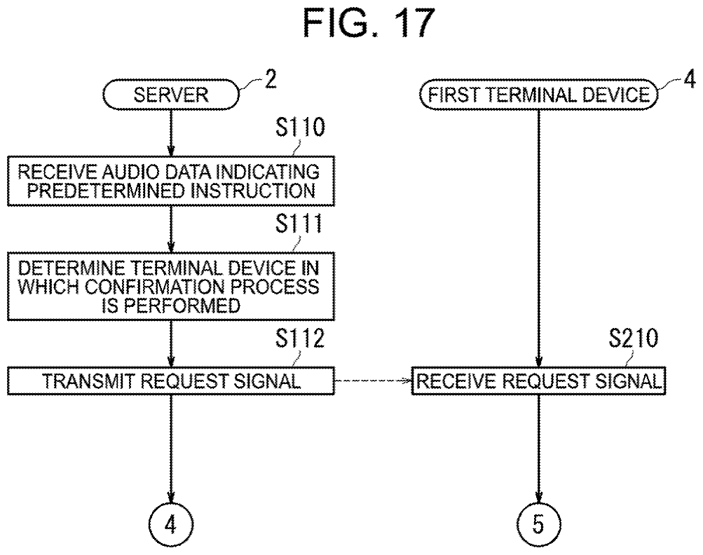

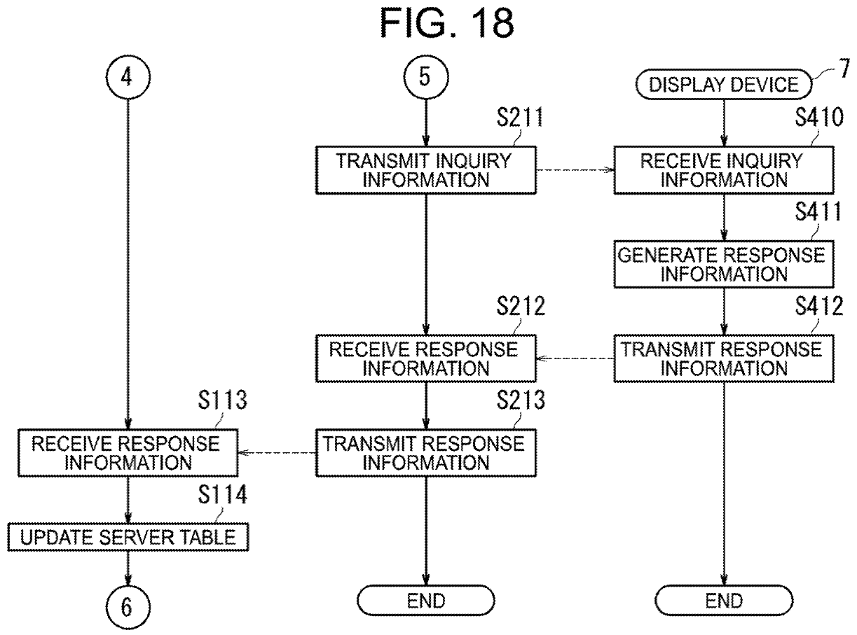

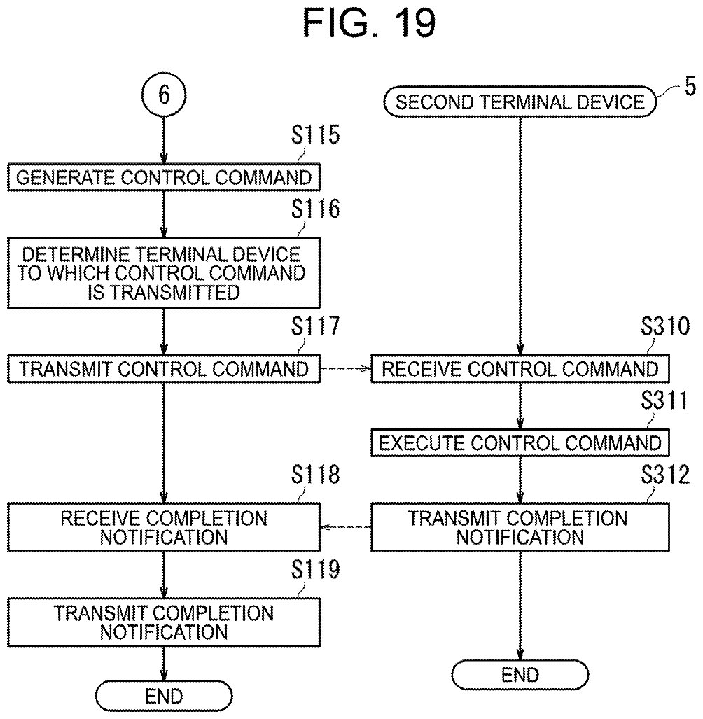

FIG. 17 is a first flowchart illustrating the second process of the information processing system 1. FIG. 18 is a second flowchart illustrating the second process of the information processing system 1. FIG. 19 is a third flowchart illustrating the second process of the information processing system 1.

As illustrated in FIGS. 15 and 17, the smart speaker 6 receives a voice indicating a predetermined instruction. In the first embodiment, the user utters “Next page” to the smart speaker 6. Accordingly, in the first embodiment, the predetermined instruction is an instruction to change the image displayed on the display device 7 to the image of the next page.

When the smart speaker 6 receives a voice indicating a predetermined instruction, the smart speaker 6 generates audio data indicating the predetermined instruction. Then, the smart speaker 6 transmits, to the server 2, the audio data indicating the predetermined instruction.

In step S110, the communicator 21 of the server 2 receives the audio data indicating the predetermined instruction from the smart speaker 6.

In step S111, the controller 24 of the server 2 determines a terminal device A that is to perform a confirmation process among the plurality of terminal devices A, based on the server table 231 after the first update shown in FIG. 12. The controller 24 determines the terminal device A whose connection state is “Displayed” in the server table 231 after the first update to be the terminal device A that is to perform the confirmation process. In the first embodiment, the first terminal device 4 is determined to be the terminal device A to perform the confirmation process.

As illustrated in steps S203 to S205 of FIG. 10, the confirmation process includes a process of transmitting the inquiry information to the display device 7, a process of receiving the response information in response to the inquiry information received from the display device 7, and a process of transmitting the response information to the server 2.

In step S112, the controller 24 controls the communicator 21 so that the communicator 21 transmits a request signal to the first terminal device 4. The request signal indicates a signal for requesting the terminal device A to perform the confirmation process.

In step S210, the first communicator 42 of the first terminal device 4 receives the request signal. If the first terminal device 4 receives the request signal, the processing proceeds to step S211 illustrated in FIG. 18. It is noted that the processes of step S211 to step S213 indicate the confirmation process.

As illustrated in FIG. 18, in step S211, the first controller 46 controls the first communicator 42 so that the first communicator 42 transmits the inquiry information to the display device 7.

In step S410, the communicator 73 of the display device 7 receives the inquiry information.

In step S411, the controller 78 generates response information in response to the inquiry information based on the device table 771 after the second update shown in FIG. 16. The response information is information indicating the device table 771 after the second update.

In step S412, the controller 78 controls the communicator 73 so that the communicator 73 transmits the response information to the first terminal device 4. If the process of step S411 ends, the processing of the display device 7 ends.

In step S212, the first communicator 42 of the first terminal device 4 receives the response information.

In step S213, the first controller 46 controls the first communicator 42 so that the first communicator 42 transmits the response information to the server 2. If the process of step S213 ends, the processing of the first terminal device 4 ends.

In step S113, the communicator 21 of the server 2 receives the response information. Specifically, the communicator 21 of the server 2 receives the response information from the display device 7 via the first terminal device 4. As a result, the server 2 recognizes that the first terminal device 4 is connected to the disabled first input terminal 71 based on the response information. Further, based on the response information, the server 2 recognizes that the second terminal device 5 is connected to the enabled second input terminal 72.

In step S114, the controller 24 of the server 2 updates the server table 231 after the first update shown in FIG. 12 based on the response information to generate the server table 231 after a second update. If the process of step S114 ends, the processing proceeds to step S115 illustrated in FIG. 19.

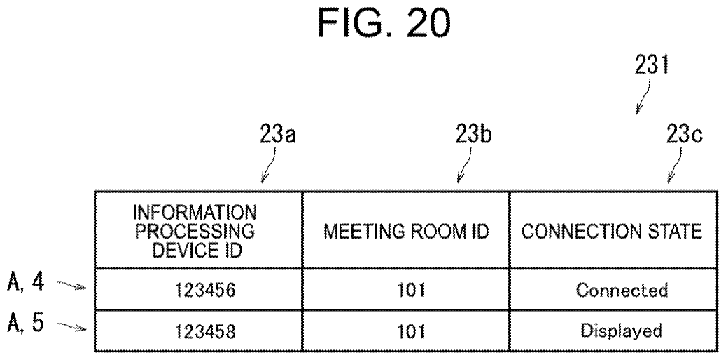

FIG. 20 shows the server table 231 after the second update.

As shown in FIG. 20, in the server table 231 after the second update, the connection state is updated to the contents reflecting the response information generated by the display device 7 in step S411. In the server table 231 after the second update, the connection state column of the first terminal device 4 is changed from “Displayed” to “Connected”. The connection state column of the second terminal device 5 is changed from “Connected” to “Displayed”.

As illustrated in FIG. 19, in step S115, the controller 24 generates a control command based on the audio data indicating the predetermined instruction received in step S110 (see FIG. 17).

A procedure for the controller 24 to generate the control command will be described. First, the voice recognizer 22 generates text data of audio data indicating a predetermined instruction. Then, the controller 24 recognizes that the audio data indicates the predetermined instruction based on the text data. Then, the controller 24 generates a control command indicating the predetermined instruction.

In the first embodiment, the predetermined instruction is an instruction to change the image displayed on the display device 7 to the image of the next page (see FIG. 15).

In step S116, the controller 24 determines a terminal device A to which the control command is transmitted, based on the server table 231 after the second update. In the server table 231 after the second update, the controller 24 determines a terminal device A whose connection state is “Displayed” to be the terminal device A to which the control command is transmitted. In the first embodiment, the controller 24 determines the second terminal device 5 to be the terminal device A to which the control command is transmitted.

In step S117, the controller 24 controls the communicator 21 so that the communicator 21 transmits the control command to the second terminal device 5.

In step S310, the second communicator 52 of the second terminal device 5 receives the control command.

In step S311, the second controller 56 executes the control command. In the first embodiment, the second controller 56 controls the second output terminal 51 so that the second output terminal 51 transmits the next image to the display device 7. The next image is transmitted from the second terminal device 5 to the display device 7 via, for example, an HDMI (registered trademark) cable. As a result, the image displayed on the display device 7 is changed to the next image. It is noted that the next image is stored in the second storage 55, for example.

In step S312, the second controller 56 controls the second communicator 52 so that the second communicator 52 transmits a completion notification to the server 2. The completion notification is a notification indicating that the process of executing the control command has been completed. If the process of step S312 ends, the processing of the second terminal device 5 ends.

In step S118, the communicator 21 of the server 2 receives the completion notification.

In step S119, the controller 24 controls the communicator 21 so that the communicator 21 transmits the completion notification to the smart speaker 6. As a result, the processing of the server 2 ends.

As described above with reference to FIGS. 15 to 20, in step S111, the controller 24 determines the terminal device A that is to perform the confirmation process among the plurality of terminal devices A. In other words, the controller 24 determines the terminal device A connected to the enabled terminal among the plurality of terminal devices A. Therefore, as illustrated in FIG. 15 and step S110, when a user operates the terminal device A connected to the enabled terminal, it is not necessary to specify the terminal device A to be operated. As a result, the user can easily operate the terminal device A connected to the enabled terminal among the plurality of terminal devices A.

Further, in step S114 of FIG. 18, when the smart speaker 6 receives the voice indicating the predetermined instruction, the server 2 acquires information indicating the device table 771 from the display device 7. Specifically, the server 2 acquires information indicating the device table 771 from the display device 7 via the first terminal device 4. Then, the server 2 updates the server table 231 based on the information indicating the device table 771. Therefore, when the smart speaker 6 receives the voice indicating the predetermined instruction, the server 2 can recognize the latest connection state of the terminal device A based on the updated server table 231.

In step S116 of FIG. 19, the server 2 determines a terminal device A to which the control command indicating the predetermined instruction is transmitted among the plurality of terminal devices A, based on the updated server table 231. Therefore, the server 2 can determine a terminal device A to which the control command is transmitted, based on the server table 231 reflecting the latest connection state. As a result, it is possible to accurately transmit the control command to the terminal device A connected to the enabled input terminal B.

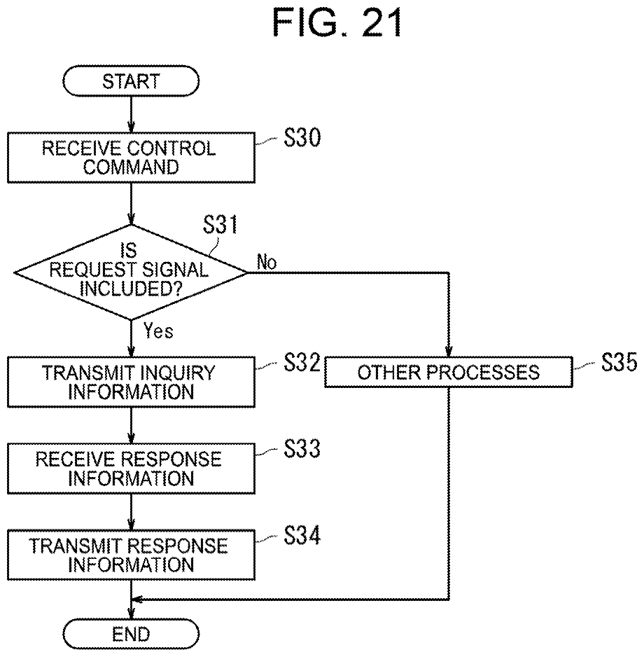

Next, a second operation of the first terminal device 4 will be described with reference to FIG. 21, FIG. 21 is a flowchart illustrating the second operation of the first terminal device 4. The second operation of the first terminal device 4 indicates an operation of the first terminal device 4 when the information processing system 1 performs the second process illustrated in FIGS. 17 to 19.

In step S30, the first communicator 42 receives the control command from the server 2.

In step S31, the first controller 46 determines whether or not the control command includes a request signal. If the first controller 46 determines that the control command includes a request signal (Yes in step S31), the processing proceeds to step S32. If the first controller 46 determines that the control command does not include a request signal (No in step S31), the processing proceeds to step S35.

In step S32, the first controller 46 controls the first communicator 42 so that the first communicator 42 transmits the inquiry information to the display device 7.

In step S33, the first communicator 42 receives the response information from the display device 7.

In step S34, the first controller 46 controls the first communicator 42 so that the first communicator 42 transmits the response information to the server 2. Therefore, even if the display device 7 and the server 2 cannot directly communicate with each other, the server 2 can acquire the response information. If the process of step S34 ends, the processing ends.

In step S35, the first controller 46 performs processes other than the confirmation process based on the text data of the audio data. As a result, the processing ends.

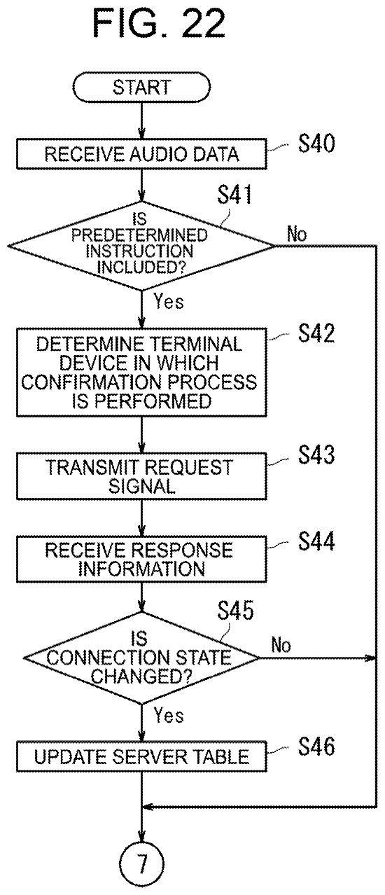

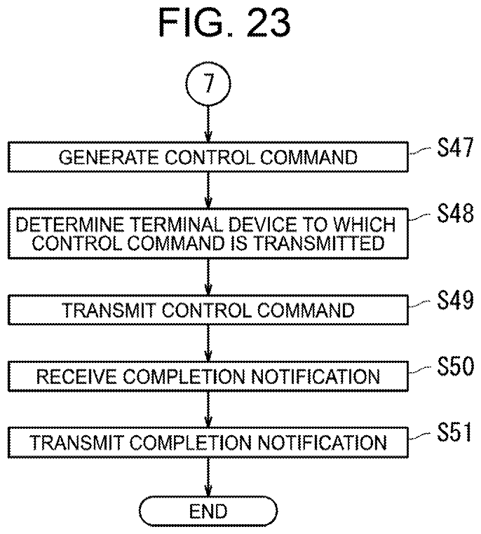

Next, a second operation of the server 2 will be described with reference to FIGS. 22 and 23. FIG. 22 is a first flowchart illustrating the second operation of the server 2. FIG. 23 is a second flowchart illustrating the second operation of the server 2. The second operation of the server 2 indicates an operation of the server 2 when the information processing system 1 performs the second process illustrated in FIGS. 17 to 19.

As illustrated in FIG. 22, in step S40, the communicator 21 receives the audio data from the smart speaker 6.

In step S41, the voice recognizer 22 generates text data indicating the audio data. Then, the controller 24 determines whether or not the text data includes information indicating the predetermined instruction. If the controller 24 determines that the text data includes information indicating the predetermined instruction (Yes in step S41), the processing proceeds to step S42. If the controller 24 determines that the text data does not include information indicating the predetermined instruction (No in step S41), the processing proceeds to step S47 illustrated in FIG. 23.

In step S42, the controller 24 determines a terminal device A that is to perform the confirmation process. In the first embodiment, as illustrated in step S111 (see FIG. 7), the first terminal device 4 is determined to be a terminal device A that is to perform the confirmation process.

In step S43, the controller 24 controls the communicator 21 so that the communicator 21 transmits a request signal to the terminal device A that is to perform the confirmation process. In the first embodiment, the request signal is transmitted to the first terminal device 4.

In step S44, the communicator 21 receives the response information from the terminal device A that has transmitted the request signal. In the first embodiment, the communicator 21 receives the response information from the first terminal device 4.

In step S45, the controller 24 determines whether or not there is a change in the connection state of the server table 231 based on the response information. If the controller 24 determines that there is a change in the connection state (Yes in step S45), the processing proceeds to step S46. If the controller 24 determines that there is no change in the connection state (No in step S45), the processing proceeds to step S47 illustrated in FIG. 23.

In step S46, the controller 24 updates the server table 231 so that the connection state of the server table 231 has contents reflecting the response information. In the first embodiment, the controller 24 updates the server table 231 after the first update shown in FIG. 12 to the server table 231 after the second update shown in FIG. 20. If the process of step S46 ends, the processing proceeds to step S47 illustrated in FIG. 23.

As illustrated in FIG. 23, in step S47, the controller 24 generates a control command based on the audio data received in step S40 (see FIG. 22).

In step S48, the controller 24 determines a terminal device A to which the control command is transmitted. In first embodiment, the controller 24 determines the second terminal device 5 to be a terminal device A to which the control command is transmitted, based on the server table 231 after the second update shown in FIG. 20.

In step S49, the controller 24 controls the communicator 21 so that the communicator 21 transmits the control command to the transmission destination of the control command determined in step S48. In the first embodiment, the control command is transmitted to the second terminal device 5.

In step S50, the communicator 21 receives a completion notification from the transmission destination of the control command.

In step S51, the controller 24 controls the communicator 21 so that the communicator 21 transmits the completion notification to the smart speaker 6. As a result, the processing ends.

### Second Embodiment

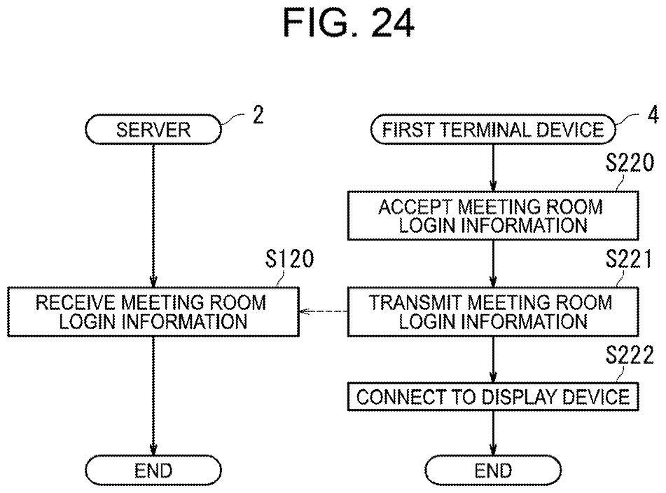

With reference to FIGS. 24 to 36, the information processing system 1 according to a second embodiment of the present invention will be described.

The second embodiment is different from the first embodiment in that a terminal device A displaying an image on the display device 7 among the plurality of terminal devices A is identified using an identification symbol such as a QR code (registered trademark). The second embodiment is also different from the first embodiment in that the display device 7 does not have the device table 771 (see FIG. 8). Hereinafter, differences from the first embodiment will be focused.

A third process of the information processing system 1 will be described with reference to FIG. 24. FIG. 24 is a flowchart illustrating the third process of the information processing system 1. The third process is a process performed by the information processing system 1 when the user participates in a meeting. The third process is a modification of the first process illustrated in FIGS. 9 and 10.

In step S220, the first operation processor 43 of the first terminal device 4 receives meeting room login information.

In step S221, the first controller 46 controls the first communicator 42 so that the first communicator 42 transmits the meeting room login information to the server 2.

In step S120, the communicator 21 of the server 2 receives the meeting room login information. As a result, the processing of the server 2 ends.

In step S222, the first terminal device 4 is connected to the first input terminal 71 of the display device 7. As a result, the processing ends.

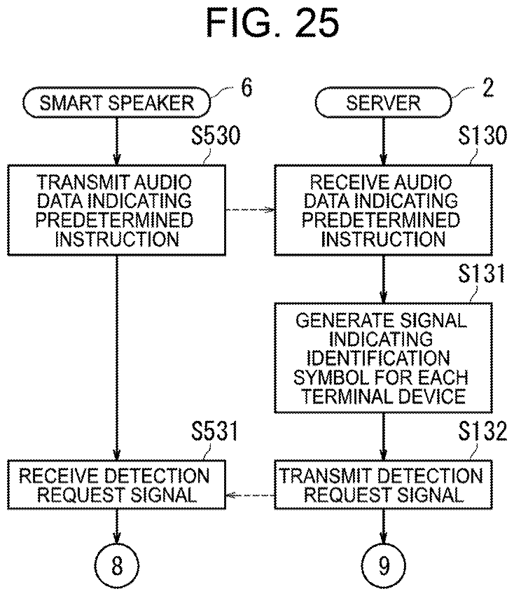

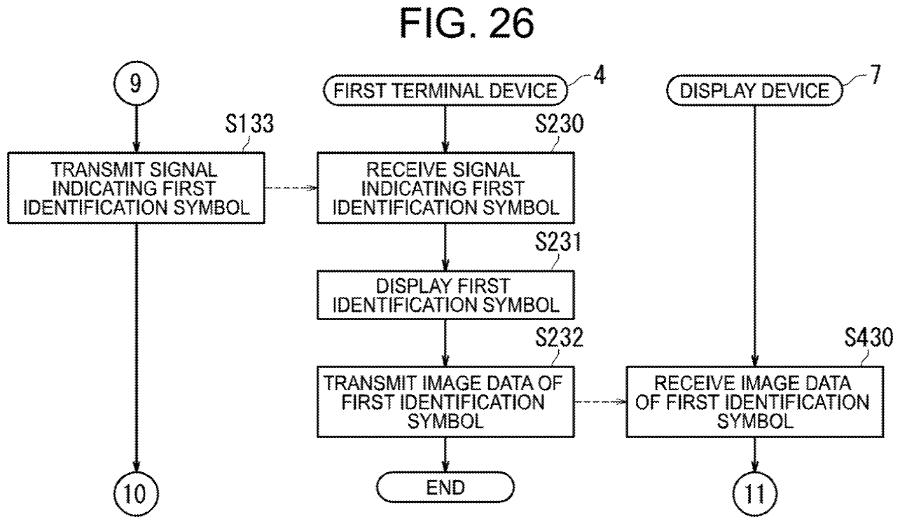

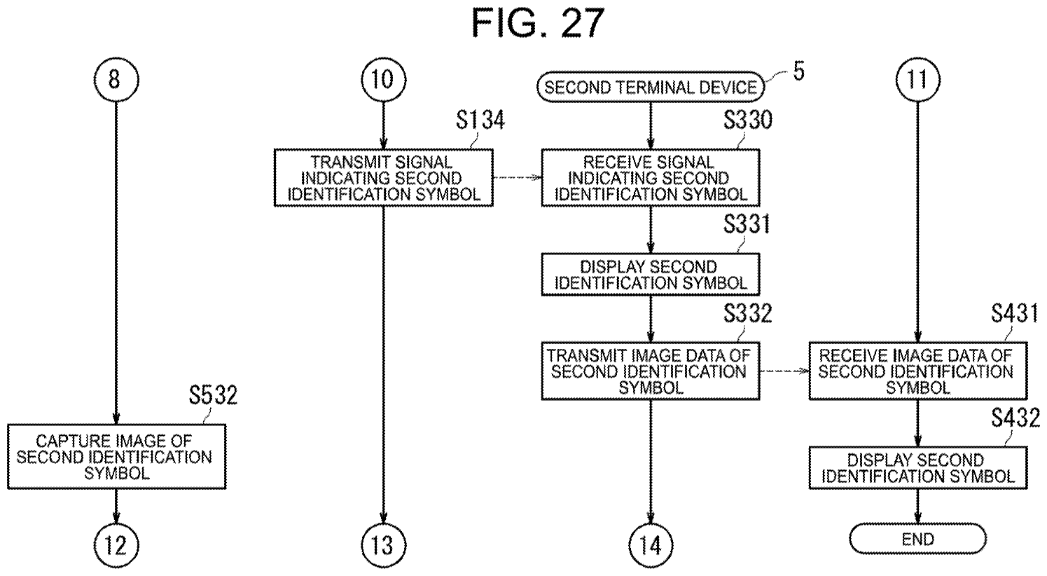

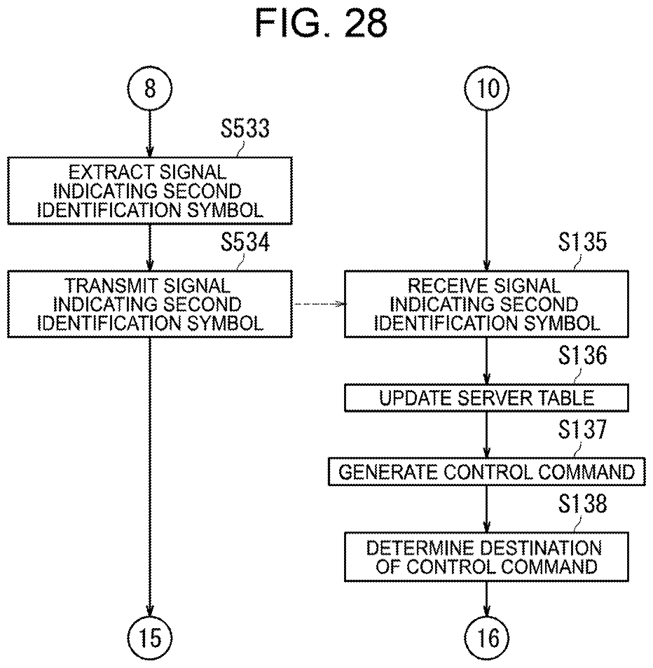

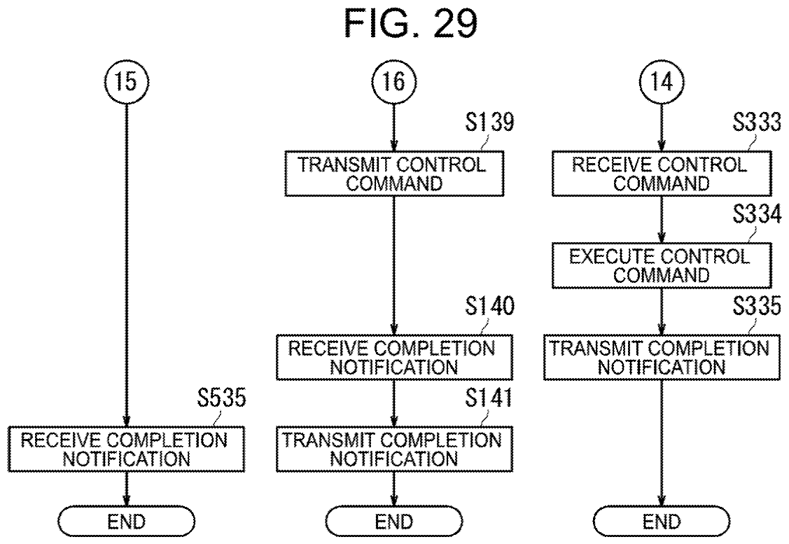

Next, a fourth process of the information processing system 1 will be described with reference to FIGS. 25 to 32. FIG. 25 is a first flowchart illustrating the fourth process of the information processing system 1. FIG. 26 is a second flowchart illustrating the fourth process of the information processing system 1. FIG. 27 is a third flowchart illustrating the fourth process of the information processing system 1. FIG. 28 is a fourth flowchart illustrating the fourth process of the information processing system 1. FIG. 29 is a fifth flowchart illustrating the fourth process of the information processing system 1.

The fourth process is a process performed by the information processing system 1 when the smart speaker 6 receives a predetermined instruction. The fourth process is a modification of the second process illustrated in FIGS. 17 to 19.

The fourth process is performed after the end of the third process illustrated in FIG. 24.

In the second embodiment, at a start of the fourth process, the server 2 has the server table 231 after the first update shown in FIG. 12. Further, at the start of the fourth process, as illustrated in FIG. 15, the same image as the image displayed on the second display 54 of the second terminal device 5 is displayed on the display 75 of the display device 7.

As illustrated in FIG. 25, in step S530, the audio inputter 62 of the smart speaker 6 receives a voice indicating a predetermined instruction. Then, the controller 66 generates audio data indicating the predetermined instruction. Then, the controller 66 controls the communicator 61 so that the communicator 61 transmits the audio data indicating the predetermined instruction to the server 2.

In step S130, the communicator 21 of the server 2 receives the audio data indicating the predetermined instruction.

In step S131, the controller 24 generates a signal indicating an identification symbol for each terminal device A. The identification symbol is a symbol for identifying each of the plurality of terminal devices A from one another. An identification symbol different from one another is generated for each of the plurality of terminal devices A.

The identification symbol includes, for example, at least one of an identifier, a character, a number, and a mark. The identifier indicates, for example, a one-dimensional code such as a barcode or a two-dimensional code such as a QR code (registered trademark). In the second embodiment, the identification symbol is a QR code (registered trademark).

In the first embodiment, the controller 24 generates a first identification symbol 4a indicating the identification symbol of the first terminal device 4 and a second identification symbol 5a indicating the identification symbol of the second terminal device 5.

The controller 24 adds information 23d indicating identification symbols to the server table 231 after the first update shown in FIG. 12 to generate the server table 231 after a third update.

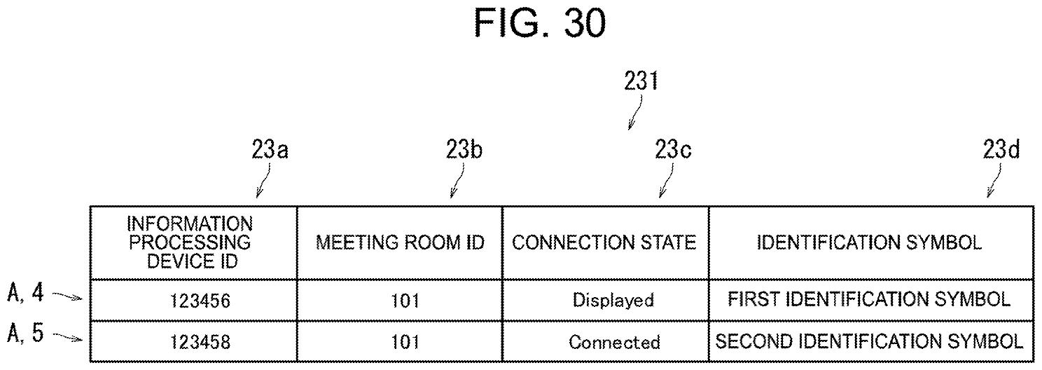

FIG. 30 shows the server table 231 after the third update. As shown in FIG. 30, in the server table 231 after the third update, an identification symbol is associated with an information processing device ID for each of the terminal devices A. In the first embodiment, the first identification symbol 4a is associated with information processing device ID “123456” of the first terminal device 4. The second identification symbol 5a is associated with information processing device ID “123458” of the second terminal device 5.

As illustrated in FIG. 25, in step S132, the controller 24 controls the communicator 21 so that the communicator 21 transmits a detection request signal to the smart speaker 6. The detection request signal is a signal for instructing the smart speaker 6 to detect an image of an identification symbol displayed on the display device 7. If the process of step S132 ends, the processing proceeds to step S133 illustrated in FIG. 26.

In step S531, the communicator 61 of the smart speaker 6 receives the detection request signal. If the communicator 61 receives the detection request signal, the controller 66 controls the imager 64 so that the imager 64 captures an image displayed on the display device 7. If the process of step S531 ends, the processing proceeds to step S133 illustrated in FIG. 26.

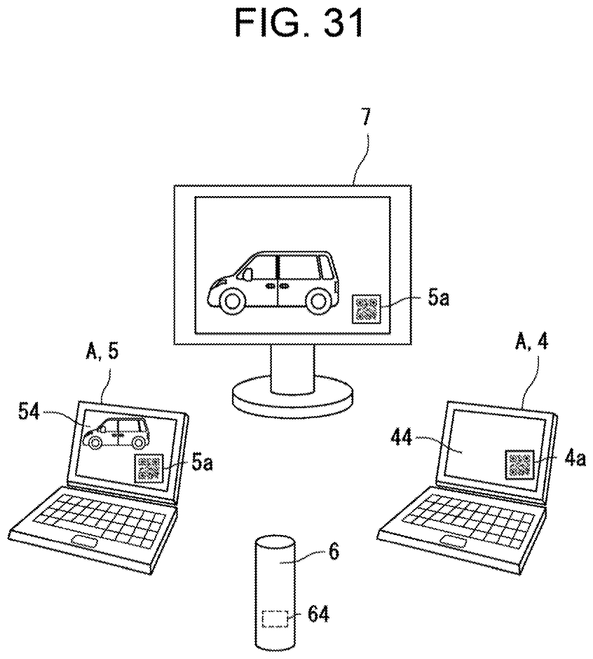

FIG. 31 is a schematic diagram illustrating the fourth process of the information processing system 1.

As illustrated in FIGS. 26 and 31, in step S133, the controller 24 controls the communicator 21 so that the communicator 21 of the server 2 transmits a signal indicating the first identification symbol 4a to the first terminal device 4. The controller 24 further controls the communicator 21 so that the communicator 21 transmits a display command to the first terminal device 4.

The display command is a control command for instructing the terminal device A to perform a process of causing the display device 7 to display the identification symbol.

In step S230, the first communicator 42 of the first terminal device 4 receives the signal indicating the first identification symbol 4a. The first communicator 42 further receives the display command.

In step S231, the first controller 46 generates image data of the first identification symbol 4a based on the signal indicating the first identification symbol 4a. Then, the first controller 46 controls the first display 44 so that the first display 44 displays the first identification symbol 4a. As a result, the first identification symbol 4a is displayed on the first display 44.

In step S232, the first controller 46 controls the first output terminal 41 so that the first output terminal 41 transmits the image data of the first identification symbol 4a to the display device 7. As a result, the processing of the first terminal device 4 ends.

The first output terminal 41 is an example of a transmitter of the present invention. The image data of the first identification symbol 4a is an example of information different from one another of the present invention.

In step S430, the first input terminal 71 of the display device 7 receives the image data of the first identification symbol 4a. However, since the first input terminal 71 is disabled, the first identification symbol 4a is not displayed on the display 75 of the display device 7. If the process of step S430 ends, the processing proceeds to step S134 illustrated in FIG. 27.

As illustrated in FIGS. 27 and 31, in step S134, the controller 24 controls the communicator 21 so that the communicator 21 of the server 2 transmits a signal indicating the second identification symbol 5a to the second terminal device 5. The controller 24 further controls the communicator 21 so that the communicator 211 transmits a display command to the second terminal device 5.

In step S330, the second communicator 52 of the second terminal device 5 receives the signal indicating the second identification symbol 5a. The second communicator 52 further receives the display command.

In step S331, the second controller 56 generates image data of the second identification symbol 5a. Then, the second controller 56 controls the second display 54 so that the second display 54 displays the second identification symbol 5a. As a result, the second identification symbol 5a is displayed on the second display 54.

In step S332, the second controller 56 controls the second output terminal 51 so that the second output terminal 51 transmits the image data of the second identification symbol 5a to the display device 7.

The second output terminal 51 is another example of the transmitter of the present invention. The image data of the second identification symbol 5a is another example of information different from one another of the present invention.

In step S431, the second input terminal 72 of the display device 7 receives the image data of the second identification symbol 5a. Then, since the second input terminal 72 is enabled, the image data of the second identification symbol 5a is input to the display device 7 via the second input terminal 72.

In step S432, the controller 78 controls the display 75 so that the display 75 displays the second identification symbol 5a. As a result, the second identification symbol 5a is displayed on the display 75. If the process of step S432 ends, the processing of the display device 7 ends.

The second identification symbol 5a displayed on the display 75 is an example of information output by the output device of the present invention.

In step S532, the imager 64 of the smart speaker 6 captures an image of the second identification symbol 5a displayed on the display 75 of the display device 7. If the process of step S532 ends, the processing proceeds to step S533 illustrated in FIG. 28,

The imager 64 is an example of an acquirer of the present invention. Capturing, by the imager 64, the image of the second identification symbol 5a displayed on the display 75 of the display device 7 is an example of acquiring, by the acquirer, the information output by the output device of the present invention.

As illustrated in FIGS. 28 and 31, in step S533, the controller 66 of the smart speaker 6 extracts a signal indicating the second identification symbol 5a from the image of the second identification symbol 5a captured by the imager 64. The controller 66 extracts the signal indicating the second identification symbol 5a by reading an image of the QR code (registered trademark) that is the second identification symbol 5a, for example.

In step S534, the controller 66 controls the communicator 61 so that the communicator 61 transmits the signal indicating the second identification symbol 5a to the server 2.

In step S135, the communicator 21 of the server 2 receives the signal indicating the second identification symbol 5a from the smart speaker 6. As a result, the controller 24 recognizes that the display device 7 is displaying the image output from the second terminal device 5. In other words, the controller 24 recognizes that the connection state of the second terminal device 5 is “Displayed”.

In step S136, the controller 24 updates the server table 231 after the third update shown inn FIG. 30 based on the signal indicating the second identification symbol 5a received from the smart speaker 6 to generate the server table 231 after a fourth update.

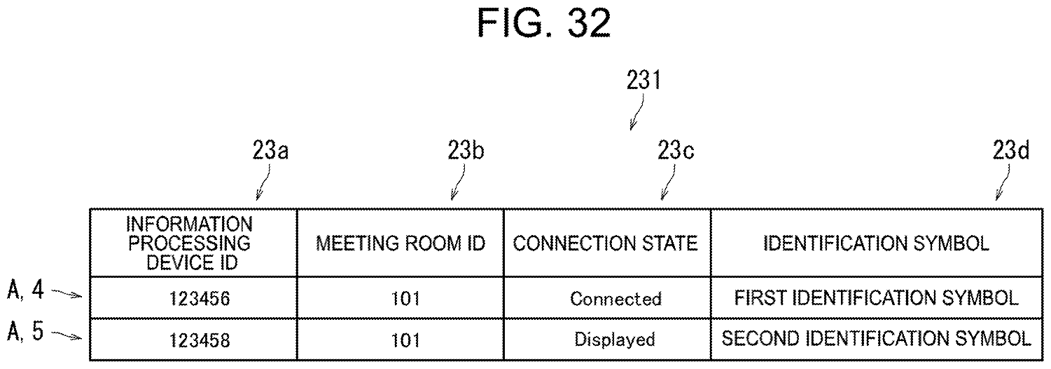

FIG. 32 shows the server table 231 after the fourth update. As shown in FIG. 32, in the server table 231 after the fourth update, the connection state of the first terminal device 4 is changed from “Displayed” to “Connected”. In the server table 231 after the fourth update, the connection state of the second terminal device 5 is changed from “Connected” to “Displayed”.

As illustrated in FIGS. 28 and 32, in step S137, the controller 24 generates a control command based on the audio data indicating the predetermined instruction received in step S130 (see FIG. 25).

In step S138, the controller 24 determines a terminal device A to which the control command is transmitted, based on the server table 231 after the fourth update. In the second embodiment, the controller 24 determines the second terminal device 5 to be a terminal device A to which the control command is transmitted. If the process of step S138 ends, the processing proceeds to step S139 illustrated in FIG. 29. It is noted that the controller 24 may determine a terminal device A to which the control command is transmitted, without using the server table 231 after the fourth update. In this case, if the controller 24 receives the signal indicating the second identification symbol 5a received from the smart speaker 6 in step S135, the controller 24 recognizes that the connection state of the second terminal device 5 is “Displayed”, and accordingly, determines the second terminal device 5 to be a terminal device A to which the control command is transmitted. As such, the controller 24 may determine a terminal device A to which the control command is transmitted among the plurality of terminal devices A based on the information output from the smart speaker 6.

As illustrated in FIG. 29, in step S139, the controller 24 controls the communicator 21 so that the communicator 21 transmits the control command to the second terminal device 5.

In step S333, the second communicator 52 of the second terminal device 5 receives the control command.

In step S334, the second controller 56 executes the control command.

In step S335, the second controller 56 controls the second communicator 52 so that the second communicator 52 transmits a completion notification to the server 2.

In step S140, the communicator 21 of the server 2 receives the completion notification.

In step S141, the controller 24 controls the communicator 21 so that the communicator 21 transmits the completion notification to the smart speaker 6. As a result, the processing of the server 2 ends.

In step S535, the communicator 61 of the smart speaker 6 receives the completion notification. As a result, the processing of the smart speaker 6 ends.

As described above with reference to FIGS. 25 to 32, when the smart speaker 6 receives the voice indicating the predetermined instruction in step S136 of FIG. 28, the server 2 updates the server table 231. Therefore, when the smart speaker 6 receives the voice indicating the predetermined instruction, the server 2 can recognize the latest connection state of the terminal device A based on the updated server table 231.

In step S138 of FIG. 28, the server 2 determines a terminal device A to which the control command indicating the predetermined instruction is transmitted among the plurality of terminal devices A based on the updated server table 231. As a result, the server 2 can accurately transmit the control command to the terminal device A connected to the enabled input terminal B.

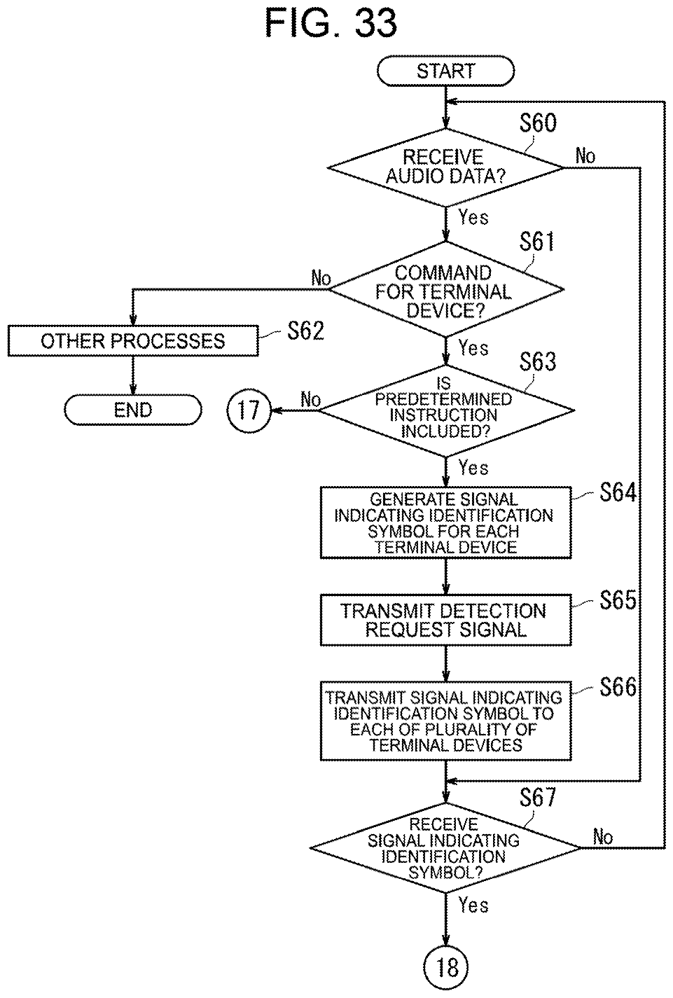

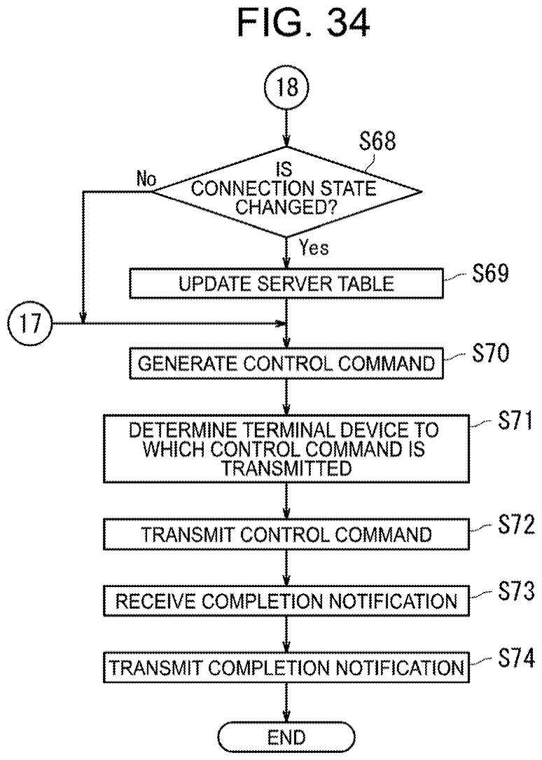

Next, a third operation of the server 2 will be described with reference to FIGS. 33 and 34. FIG. 33 is a first flowchart illustrating the third operation of the server 2. FIG. 34 is a second flowchart illustrating the third operation of the server 2. The third operation of the server 2 is an operation of the server 2 when the information processing system 1 performs the fourth process illustrated in FIGS. 25 to 29.

As illustrated in FIG. 33, in step S60, the controller 24 determines whether or not the communicator 21 has received the audio data. If the controller 24 determines that the audio data has been received (Yes in step S60), the processing proceeds to step S61. If the controller 24 determines that no audio data has been received (No in step S60), the processing proceeds to step S67.

In step S61, the voice recognizer 22 generates text data indicating the audio data. Then, the controller 24 determines whether or not the command indicated by the text data is a command for the terminal device A. If the controller 24 determines that the command is not for the terminal device A (No in step S61), the processing proceeds to step S62. If the controller 24 determines that the command is for the terminal device A (Yes in step S61), the processing proceeds to step S63.

In step S62, the controller 24 performs processes other than the process for the terminal device A based on the text data.

In step S63, the controller 24 determines whether or not the text data includes information indicating a predetermined instruction. If the controller 24 determines that the text data includes information indicating a predetermined instruction (Yes in step S63), the processing proceeds to step S64. If the controller 24 determines that the text data does not include information indicating a predetermined instruction (No in step S63), the processing proceeds to step S70 illustrated in FIG. 34.

In step S64, the controller 24 generates a signal indicating an identification symbol for each terminal device A.

In step S65, the controller 24 controls the communicator 21 so that the communicator 21 transmits a detection request signal to the smart speaker 6.

In step S66, the controller 24 controls the communicator 21 so that the communicator 21 transmits the signal indicating the identification symbol to each of the plurality of terminal devices A. In the second embodiment, a signal indicating the first identification symbol 4a is transmitted to the first terminal device 4. A signal indicating the second identification symbol 5a is transmitted to the second terminal device 5.

In step S67, the controller 24 determines whether or not the communicator 21 has received the signal indicating the identification symbol.

If the controller 24 determines that the signal indicating the identification symbol has been received (Yes in step S67), the processing proceeds to step S68 illustrated in FIG. 34. In the second embodiment, the communicator 21 receives the second identification symbol 5a in step S135 illustrated in FIG. 28.

If the controller 24 determines that the signal indicating the identification symbol has not been received (No in step S67), the processing proceeds to step S60.

As illustrated in FIG. 34, in step S68, the controller 24 determines whether or not there is a change in the connection state of the server table 231. If the controller 24 determines that there is a change in the connection state (Yes in step S68), the processing proceeds to step S69. If the controller 24 determines that there is no change in the connection state (No in step S68), the processing proceeds to step S70.

In step S69, the controller 24 updates the server table 231. In the second embodiment, the controller 24 updates the server table 231 after the third update shown in FIG. 30 to the server table 231 after the fourth update shown in FIG. 32.

In step S70, the controller 24 generates a control command based on the audio data received in step S60 (see FIG. 33).

In step S71, the controller 24 determines a terminal device A to which the control command is transmitted. In the second embodiment, the controller 24 determines the second terminal device 5 to be a terminal device A to which the control command is transmitted based on the server table 231 after the fourth update shown in FIG. 32.

In step S72, the controller 24 controls the communicator 21 so that the communicator 21 transmits the control command to the transmission destination of the control command determined in step S71. In the second embodiment, the control command is transmitted to the second terminal device 5.

In step S73, the communicator 21 receives a completion notification from the transmission destination of the control command.

In step S74, the controller 24 controls the communicator 21 so that the communicator 21 transmits the completion notification to the smart speaker 6. As a result, the processing ends.

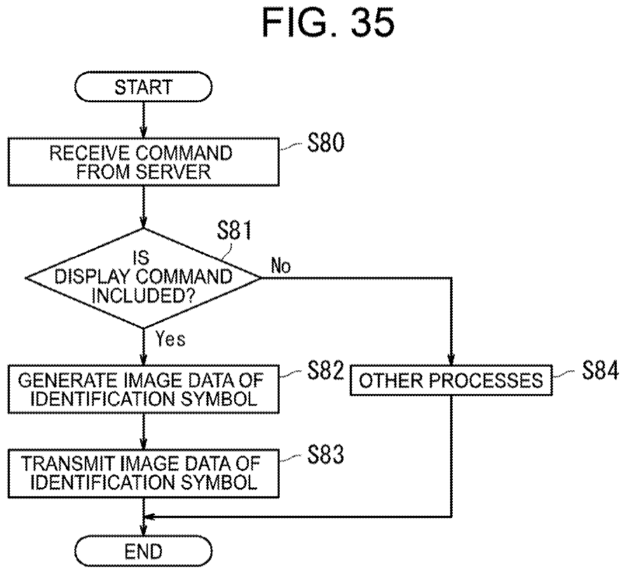

A third operation of the first terminal device 4 will be described with reference to FIG. 35. FIG. 35 is a flowchart illustrating the third operation of the first terminal device 4. The third operation of the first terminal device 4 is an operation of the first terminal device 4 when the information processing system 1 performs the fourth process illustrated in FIGS. 25 to 29.

As illustrated in FIG. 35, in step S80, the first communicator 42 receives a command from the server 2.

In step S81, the first controller 46 determines whether or not the command received from the server 2 includes a display command.

If the first controller 46 determines that the command includes a display command (Yes in step S81), the processing proceeds to step S82. In this case, the first communicator 42 receives the signal indicating the first identification symbol 4a with the display command. (see step S230 of FIG. 26).

If the first controller 46 determines that the command does not include a display command (No in step S81), the processing proceeds to step S84.

In step S82, the first controller 46 generates image data of the first identification symbol 4a based on the signal indicating the first identification symbol 4a.

In step S83, the first controller 46 controls the first output terminal 41 so that the first output terminal 41 transmits the image data of the first identification symbol 4a to the display device 7. As a result, the processing ends.

In step S84, the first controller 46 performs a process of step S82 and processes other than the process of step S82 based on the command received from the server 2. As a result, the processing ends.

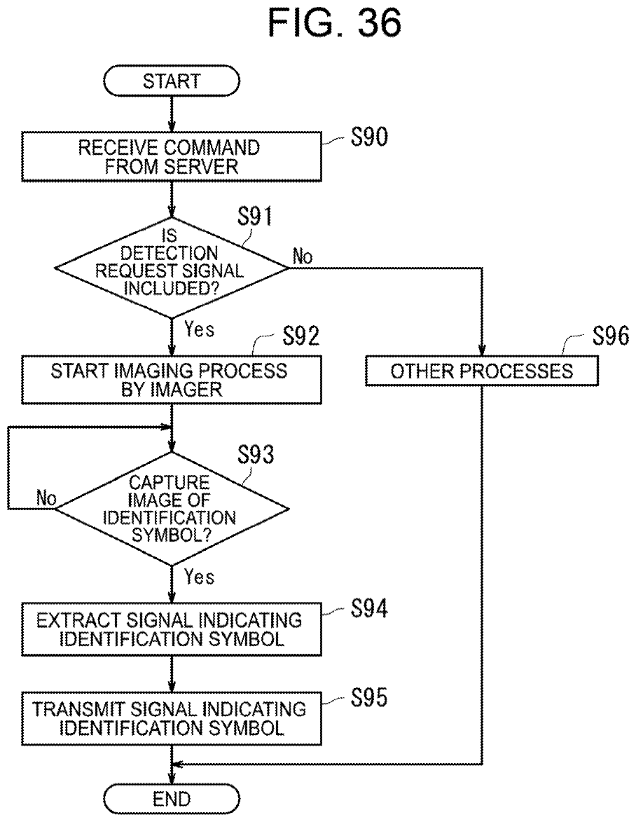

An operation of the smart speaker 6 will be described with reference to FIG. 36. FIG. 36 is a flowchart illustrating the operation of the smart speaker 6. The operation of the smart speaker 6 is an operation of the smart speaker 6 when the information processing system 1 performs the fourth process illustrated in FIGS. 25 to 29.

As illustrated in FIG. 36, in step S90, the communicator 61 receives a command from the server 2.

As illustrated in step S91, the controller 66 determines whether or not the command received from the server 2 includes a detection request signal. If the controller 66 determines that the command includes a detection request signal (Yes in step S91), the processing proceeds to step S92. If the controller 66 determines that the command does not include a detection request signal (No in step S91), the processing proceeds to step S96.

In step S92, the controller 66 controls the imager 64 to start an imaging process. The imaging process is a process for the imager 64 to capture an image displayed on the display 75 of the display device 7.

In step S93, the controller 66 determines whether or not the imager 64 has captured the image of the identification symbol. In the second embodiment, the image of identification symbol is one of the image of the first identification symbol 4a and the image of the second identification symbol 5a (see FIG. 31).

If the controller 66 determines that the imager 64 has captured the image of the identification symbol (Yes in step S93), the processing proceeds to step S94. If the controller 66 determines that the imager 64 has not captured the image of the identification symbol (No in step S93), the process of step S93 is repeated.

In step S94, the controller 66 extracts a signal indicating the identification symbol from the image of the identification symbol captured by the imager 64. In the second embodiment, as illustrated in FIG. 31, the image of the second identification symbol 5a is displayed on the display 75 of the display device 7. Accordingly, the imager 64 captures the image of the second identification symbol 5a. As a result, the controller 66 extracts a signal indicating the second identification symbol 5a.

In step S95, the controller 66 controls the communicator 61 so that the communicator 61 transmits the signal indicating the identification symbol to the server 2. In the second embodiment, the communicator 61 transmits the signal indicating the second identification symbol 5a to the server 2. If the process of step S95 ends, the processing ends.

In step S96, the controller 66 performs processes other than the processes of steps S92 and S95 based on the command received from the server 2. As a result, the processing ends.

The embodiments of the present invention have been described above with reference to the drawings (FIGS. 1 to 36). The present invention is not limited to the above embodiments, and may be applied to other configurations (for example, the following (1) to (9)) without departing from the spirit and scope of the present invention. In addition, various configurations may be made by appropriately combining a plurality of constituent elements disclosed in the above embodiments. For example, some constituent elements may be deleted from all the constituent elements illustrated in the embodiments. The drawings schematically illustrate the respective constituent elements mainly for the sake of easy understanding, and the number or the like of each of the constituent elements illustrated may be different from the actual ones on account of preparation of the drawings. Further, the constituent elements illustrated in the above-described embodiments are merely examples, and are not particularly limited, and various modifications can be made without substantially departing from the advantageous effects of the present invention.

(1) In the second embodiment, when the controller 24 of the server 2 determines a terminal device A displaying an image on the display device 7 among the plurality of terminal devices A, an identification symbol such as a QR code (registered trademark) is used. However, the present invention is not limited to this. Instead of the identification symbol, visible light communication, image recognition, or ultrasonic waves may be used.

An operation of the information processing system 1 when visible light communication is used will be described. Blinking the backlight of the display 75 of the display device 7 makes an output of blink information of the display device 7. The blink information includes information indicating the terminal device A displaying an image on the display device 7 among the plurality of terminal devices A. The server 2 determines the terminal device A displaying an image on the display device 7 among the plurality of terminal devices A based on the blink information. As a result, the server 2 can recognize the enabled input terminal B among the plurality of input terminals B.

An operation of the information processing system 1 when image recognition is used will be described. A first image is displayed on the first display 44 of the first terminal device 4. A second image is displayed on the second display 54 of the second terminal device 5. A third image is displayed on the display 75 of the display device 7. The imager 64 captures the third image. The first terminal device 4 transmits image data indicating the first image to the server 2. The second terminal device 5 transmits image data indicating the second image to the server 2. The smart speaker 6 transmits image data indicating the third image to the server 2. The server 2 compares the first image, the second image, and the third image by, for example, pattern matching.

If the third image includes the first image, the server 2 determines that the terminal device A displaying an image on the display device 7 is the first terminal device 4. On the other hand, if the third image includes the second image, the server 2 determines that the terminal device A displaying an image on the display device 7 is the second terminal device 5.

An operation of the information processing system 1 when ultrasonic waves are used will be described. The information processing system 1 includes an audio output device (not illustrated) that outputs audio. The audio output device is, for example, a speaker. The audio output device is another example of the output device of the present invention.

The first terminal device 4 transmits first sound wave data to the audio output device. The second terminal device 5 transmits second sound wave data to the audio output device. If the first input terminal 71 is enabled, the audio output device outputs a first sound wave. The first sound wave is an ultrasonic wave indicated by the first sound wave data. If the second input terminal 72 is enabled, the audio output device outputs a second sound wave. The second sound wave is an ultrasonic wave indicated by the second sound wave data.

If the audio output device outputs the first sound wave, the server 2 determines that the terminal device A displaying an image on the display device 7 is the first terminal device 4. On the other hand, if the audio output device outputs the second sound wave, the server 2 determines that the terminal device A displaying an image on the display device 7 is the second terminal device 5.

(2) If a person other than the owner of a predetermined terminal device inputs an instruction to the smart speaker 6 by voice, a predetermined input field may be displayed on the display of the predetermined terminal device. As the predetermined terminal device, the terminal device A displaying an image on the display device 7 indicates the first terminal device 4. The predetermined input field is an input field for inputting a result of examination as to whether or not the predetermined terminal device is permitted to perform an operation based on the instruction. For example, if a person other than the Owner of the predetermined terminal device utters “Display materials for meeting C” to the smart speaker 6, a first input icon and a second input icon are displayed on the display of the predetermined terminal device. The first input icon is an icon for accepting permission to display materials for meeting C. The second input icon is an icon for accepting refusal to display materials for meeting C. As a result, the security of the information processing system 1 can he improved.

(3) A plurality of images such as picture-in-picture may be displayed on the display 75 of the display device 7. In this case, in the first embodiment, a terminal device A displaying an image on a main screen of the display device 7 and a terminal device A displaying an image on a sub screen of the display device 7 are determined among the plurality of terminal devices A.

(4) The information processing device of the present invention functions as the server 2 in the first embodiment and the second embodiment. However, the present invention is not limited to this. The information processing device of the present invention may be installed, for example, in the display device 7, may be installed in the smart speaker 6, or may be installed in a device different from the display device 7 and the smart speaker 6.

(5) In the first embodiment and the second embodiment, the server 2 generates text data based on audio data and also executes a control command indicated by the text data. However, the present invention is not limited to this. A server that generates the text data and a server that executes the control command may be provided separately.

(6) In the first embodiment and the second embodiment, the server 2 generates text data of audio data. However, the present invention is not limited to this. Instead of the server 2, the smart speaker 6 may generate the text data. Further, an external device different from the server 2 and the smart speaker 6 may generate the text data.

(7) In the first embodiment and the second embodiment, the plurality of terminal devices A are connected by wire to the plurality of input terminals B. However, the present invention is not limited to this. The plurality of terminal devices A may be wirelessly connected to the communicator 73 (see FIG. 6). The communicator 73 is another example of the inputter of the present invention. Data transmission between the plurality of terminal devices A and the communicator 73 is executed in compliance with, for example, the Miracast (registered trademark) standard. In this case, among signals from the plurality of terminal devices A received by the communicator 73, the controller 78 processes only a signal from one terminal device A and does not process signals from the remaining terminal devices A. In other words, among the plurality of terminal devices A, one terminal device A is connected to input a signal to the communicator 73, and the remaining terminal devices A are connected not to input a signal to the communicator 73. Also, in this case, as in the first embodiment and the second embodiment, for example, a terminal device A that can input a signal to the communicator 73 is changed to one of the plurality of terminal devices A through an operation of the operation processor 76.

(8) The reception device of the present invention is not limited to the smart speaker 6. The reception device of the present invention may be any device that can receive an input of information from the outside. The reception device of the present invention is, for example, a device such as a chat device that receives an input of a character, a device such as a camera that receives a landscape input (image capturing) to generate landscape image data, or a sensor that receives an input of gesture motion.

(9) As illustrated in FIGS. 17 and 18, if the server 2 receives audio data indicating a predetermined instruction from the smart speaker 6, the server 2 updates the server table 231. However, the present invention is not limited to this. The server 2 may update the server table 231 at a predetermined timing without receiving audio data indicating a predetermined instruction from the smart speaker 6. For example, if it is known in advance that audio data indicating a predetermined instruction is input to the smart speaker 6 five minutes before the end of a meeting, the server 2 may update the server table 231 immediately prior to five minutes before the end of the meeting (at a predetermined timing). After that, if receiving audio data indicating a predetermined instruction from the smart speaker 6, the server 2 generates a control command based on the audio data indicating the predetermined instruction without performing a process of updating the server table 231. As a result, it is possible to smoothly perform the process of generating the control command. Information indicating the predetermined timing is stored in the storage 23 of the server 2 in advance. The controller 24 of the server 2 functions as a timer to count a predetermined timing.

The present invention can be used in the fields of an information processing system, an information processing device, and an information processing method.

What is claimed is:

1. An information processing system, comprising:
a server capable of controlling a plurality of terminal devices; and
an output device including an inputter that is connectable with the plurality of terminal devices by wire or wirelessly, wherein
the server includes a controller that determines a terminal device connected to the inputter, the terminal device inputting a signal to the inputter, among the plurality of terminal devices.

2. The information processing system according to claim 1, wherein the output device includes a plurality of input terminals connectable to the plurality of terminal devices by wire,
the controller determines a terminal device connected to an enabled terminal among the plurality of terminal devices, and
the enabled terminal indicates an enabled input terminal among the plurality of input terminals.

3. The information processing system according to claim 2, wherein the server includes a server storage that stores a server table,
the server table includes, for each of the terminal devices, information indicating a connection state of the terminal device with respect to the input terminal, and
the controller determines the terminal device connected to the enabled terminal based on the server table.

4. The information processing system according to claim 3, wherein the output device or the server includes a device storage that stores a device table, and
the device table stores, for each of the input terminals, an information processing device ID of the terminal device connected to the input terminal and a terminal state indicating whether or not the input terminal is enabled in association with each other.

5. The information processing system according to claim 4, wherein when a first terminal device indicating any one of the plurality of terminal devices is connected to a first input terminal indicating any one of the plurality of input terminals, the output device updates the device table, and
the information processing device ID of the first terminal device is added to the updated device table.

6. The information processing system according to claim 5, wherein the server updates the server table based on the updated device table.

7. The information processing system according to claim 4, further comprising a reception device that receives an input of information from an outside, wherein
when the reception device receives a predetermined instruction, the server acquires information indicating the device table from the output device, and updates the server table based on the information indicating the device table.

8. The information processing system according to claim 4, wherein the server acquires information indicating the device table from the output device at a predetermined timing, and updates the server table based on the information indicating the device table.

9. The information processing system according to claim 3, further comprising a reception device that receives an input of information, wherein
each of the plurality of terminal devices includes a transmitter that transmits different information to the output device, and
when the reception device receives a predetermined instruction, the server updates the server table based on information output by the output device.

10. The information processing system according to claim 7, wherein the server determines a terminal device to which a control command indicating the predetermined instruction is transmitted among the plurality of terminal devices, based on the updated server table.

11. The information processing system according to claim 2, further comprising a reception device that receives an input of information, wherein
each of the plurality of terminal devices includes a transmitter that transmits different information to the output device, and
when the reception device receives a predetermined instruction, the server determines a terminal device to which a control command indicating the predetermined instruction is transmitted, among the plurality of terminal devices, based on information output by the output device.

12. An information processing device, comprising a controller capable of controlling a plurality of terminal devices, wherein
the plurality of terminal devices are connectable to an inputter included in an output device by wire or wirelessly, and
the controller determines a terminal device connected to the inputter, the terminal device inputting a signal to the inputter, among the plurality of terminal devices.

13. An information processing method using; a server capable of controlling a plurality of terminal devices; and
an output device including an inputter that is connectable with the plurality of terminal devices by wire or wirelessly, the method comprising:
determining, by the server, a terminal device connected to the inputter, the terminal device inputting a signal to the inputter, among the plurality of terminal devices.
